(19) United States
(12) Patent Application Publication
(10) Pub. No.: US 2014/0219370 A1
(43) Pub. Date: Aug. 7, 2014

(54) SIGNAL PROCESSING IN A COOPERATIVE OFDM COMMUNICATION SYSTEM

(71) Applicant: Transpacific IP Management Group Ltd., Taiwan (CN)

(72) Inventors: Hai-Wei Wang, Taiwan (CN); David W. Lin, Taiwan (CN); Tzu-Hsien Sang, Taiwan (CN)

(21) Appl. No.: 13/924,307

(22) Filed: Jun. 21, 2013

Related U.S. Application Data
(60) Provisional application No. 61/761,611, filed on Feb. 6, 2013.

(51) Int. Cl. H04L 27/26

(52) U.S. Cl. CPC H04L 27/2649
USPC 375/260; 375/343; 375/341

(57) ABSTRACT

A receiver for processing frequency division multiplexing (FDM) signals, the receiver includes a processor configured to: convert the FDM signals from at least two transmitters into frequency domain signals; determine a first component of the frequency domain signals, the first component of the frequency domain signals comprising a channel noise and a composite residual inter-carrier interference (ICI) contributed by the at least two transmitters; calculate a set of correlation values corresponding to the first component of the frequency domain signals; and process the first component of the frequency domain signals based on the set of correlation values.

### RELATED APPLICATION

This application claims priority to U.S. Provisional Application No. 61/761,611, filed Feb. 6, 2013, which is hereby incorporated by reference in its entirety.

### BACKGROUND

The present disclosure relates generally to a frequency-division multiplexing (FDM) communication. For example, the present disclosure relates to a device and a method for processing orthogonal frequency-division multiplexing (OFDM) signals in a cooperative communication system.

A cooperative communication system may achieve spatial diversity gains by employing distributed multi-transmitters. Normally, every single distributed transmitter in the cooperative communication system may rarely have accurately aligned carrier frequency. Accordingly, multiple carrier frequency offsets (MCFOs) may occur due to a receiver may constantly have high relative velocity with respect to the distributed multi-transmitters. Moreover, Doppler shifts or Doppler spread in channel response, as well as uncorrected CFOs, may result in inter-carrier interference (ICI). The MCFOs and ICI may severely deteriorate the performance of a cooperative communication system using an orthogonal frequency-division multiplexing (OFDM) scheme.

It may therefore be desirable to have a device and a method to mitigate the MCFOs and ICI in the cooperative OFDM communication system.

### BRIEF SUMMARY

A simplified summary is provided herein to help enable a basic or general understanding of various aspects of non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

Example embodiments may provide a receiver for processing frequency division multiplexing (FDM) signals, the receiver includes a processor configured to: convert the FDM signals from at least two transmitters into frequency domain signals; determine a first component of the frequency domain signals, the first component of the frequency domain signals comprising a channel noise and a composite residual inter-carrier interference (ICI) contributed by the at least two transmitters; calculate a set of correlation values corresponding to the first component of the frequency domain signals; and process the first component of the frequency domain signals based on the set of correlation values.

Some example embodiments may provide a method for processing frequency-division multiplexing (FDM) signals, the method includes the steps of: receiving the FDM signals from at least two transmitters; converting the FDM signals to frequency domain signals; determining a first component of the frequency domain signals, the first component of the frequency domain signals comprising a channel noise and a composite residual inter-carrier interference (ICI) contributed by the at least two transmitters; calculating a set of correlation values corresponding to the first component of the frequency domain signals; and processing the first component of the frequency domain signals based on the set of correlation values.

It is to be understood that both the foregoing general description and the following detailed description are exemplary and explanatory only and are not restrictive. Therefore, the disclosed subject matter should not be limited to any single embodiment, or group of embodiments described herein, but rather should be construed in breadth and scope in accordance with the appended claims.

### BRIEF DESCRIPTION OF THE DRAWINGS

The foregoing summary, as well as the following detailed description of the various embodiments, will be better understood when read in conjunction with the appended drawings. For the purpose of illustrating the various embodiments, there are shown in the drawings various examples. It should be understood, however, that the various embodiments are not limited to the precise arrangements and instrumentalities shown and that other similar embodiments can be used or modifications and additions can be made to the described embodiments for performing the same, similar, alternative, or substitute function of the disclosed subject matter without deviating therefrom.

Numerous aspects, embodiments, objects and advantages of the present invention will be apparent upon consideration of the following detailed description, taken in conjunction with the accompanying drawings, in which like reference characters refer to like parts throughout, and in which:

FIG. 1 is a block diagram of the baseband part of a cooperative orthogonal frequency-division multiplexing (OFDM) communication system in accordance with an example embodiment;

FIG. 2 illustrates a channel matrix of a channel in the cooperative OFDM communication system illustrated in FIG. 1 in accordance with an example embodiment;

FIG. 3A is a block diagram of the baseband part of a cooperative OFDM communication system in accordance with another example embodiment;

FIG. 3B illustrates channel matrices of the channels in the cooperative OFDM communication system illustrated in FIG. 3A in accordance with another example embodiment;

FIG. 4A is a block diagram of a device for performing the blockwise whitening process and a signal detector in the cooperative OFDM communication system illustrated in FIG. 3A in accordance with another example embodiment;

FIG. 4B illustrates the sub-vectors in the cooperative OFDM communication system illustrated in FIG. 3A in accordance with another example embodiment;

FIG. 4C illustrates a channel sounding method performed by the channel estimators illustrated in FIG. 4A in accordance with another example embodiment;

FIG. 4D illustrates the channel matrices of the channels in the cooperative OFDM communication system illustrated in FIG. 3A in accordance with another example embodiment;

FIG. 4E illustrates an operation for calculating composite residual ICI plus channel noise in the blockwise whitening process in accordance with another example embodiment;

FIG. 4F is a block diagram of a device for performing the blockwise whitening process and the signal detection in accordance with yet another example embodiment;

FIG. 4G is a block diagram of a device for performing the blockwise whitening process and a device for performing the signal detection in accordance with still another example embodiment;

FIG. 5A illustrates an Alamouti-type coding for the cooperative OFDM communication system illustrated in FIG. 3A in accordance with another example embodiment;

FIG. 5B illustrates carrier frequency offsets (CFOs) in the cooperative OFDM communication system illustrated in FIG. 3A in accordance with another example embodiment;

FIG. 5C illustrates sub-matrices of the channels as well as corresponding sub-vectors in the cooperative OFDM communication system illustrated in FIG. 3A in accordance with another example embodiment;

FIG. 5D illustrates CFOs in a cooperative OFDM communication system in accordance with still another example embodiment;

FIG. 5E illustrates the channel matrices of the channels in the cooperative OFDM communication system illustrated in FIG. 5D in accordance with still another example embodiment; and

FIG. 5F illustrates the sub-matrices of the channels as well as corresponding sub-vectors in the cooperative OFDM communication system illustrated in FIG. 5D in accordance with still another example embodiment.

### DETAILED DESCRIPTION

Reference will now be made in detail to the present examples of the various embodiments, examples of which are illustrated in the accompanying drawings. Wherever possible, the same reference numbers will be used throughout the drawings to refer to the same or like parts.

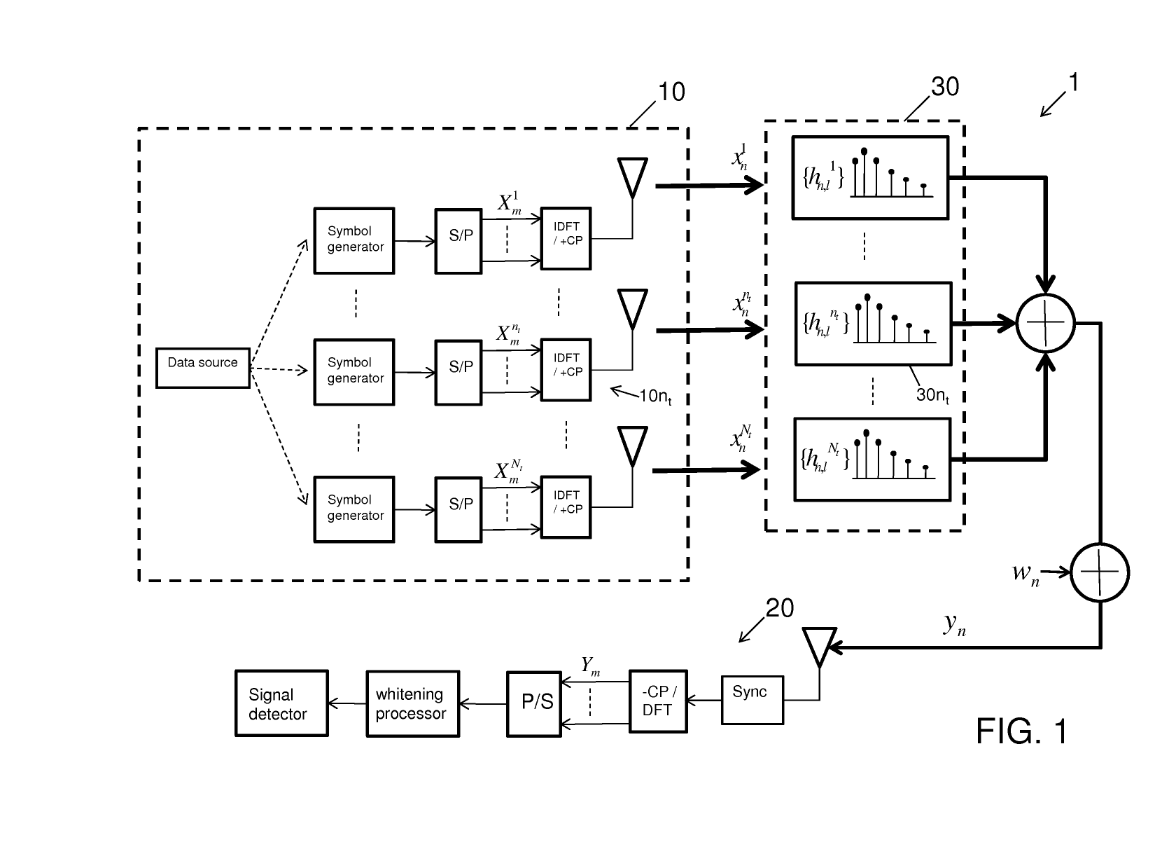

FIG. 1 is a block diagram of the baseband part of a cooperative orthogonal frequency-division multiplexing (OFDM) communication system 1 in accordance with an example embodiment. Referring to FIG. 1, the cooperative OFDM communication system 1 may include a plurality of transmitters 10 and a receiver 20. In this example embodiment, the number of the plurality of transmitters 10 may be denoted as Nₜ, and the Nₜ transmitters 10 may be communicatively coupled to the receiver 20 through a plurality of channels 30 respectively. That is, a channel 30nₜ of the channels 30 may correspond to the (nₜ-th) transmitter 10nₜ of the Nₜ transmitters 10 (wherein 1≦nₜ≦Nₜ), and the transmitter 10nₜ may be communicatively coupled to the receiver 20 through the channel 30nₜ.

The transmitters 10 may be configured to transmit signals to the receiver 20 through the channels 30 respectively. Specifically, the signal transmitted by the transmitter 10nₜ may be denoted as xₙⁿ^{ₜ} with discrete time index “n” and the signal xₙⁿ^{ₜ} may be transmitted to the receiver 20 through the channel 30nₜ. The channel 30nₜ may include a time-varying multipath fading channel, which may be characterized by a set of discrete-time complex gains denoted as {h_{n,l}ⁿ^{ₜ}} with “n” denoting the discrete time index and “l” denoting the channel path index. That is, h_{n,l}ⁿ^{ₜ} may direct to a complex gain of the l-th channel path at time n that corresponds to the transmitter 10nₜ. In one example embodiment of the present invention each of the channels 30 in the cooperative OFDM communication system 1 may be wide-sense stationary uncorrelated scattering (WSSUS) as characterized by the following equation:

E[h_{n,l}ⁿ^{ₜₕ}_{n-q,l-m}ⁿ^{ₜ}^{*}]=σ_{l,n}_{ₜ}²γₗⁿ^{ₜ}(q)δ(m) eq. (1)

In equation (1), the terms σ_{l,n}_{ₜ}², γₗⁿ^{ₜ}(q) and δ(m) may be defined as the following:

σ_{l,n}_{ₜ}² may denote the variance of the tap gain hₗⁿ^{ₜ} of the l-th channel path of the channel 30nₜ,

γₗⁿ^{ₜ}(q) may denote the normalized autocorrelation function of the tap gain hₗⁿ^{ₜ} of the l-th channel path of the channel 30nₜ with γₗⁿ^{ₜ}(0)=1, and

δ(m) may denote the Kronecker delta function.

Furthermore, the operation E[.] may denote expectation, and the superscript “*” may denote complex conjugation.

Moreover, the l-th channel path of the channel 30nₜ may have a normalized Doppler power spectral density (PSD) P_{l,n}_{ₜ}(f), and the mentioned normalized autocorrelation function γₗⁿ^{ₜ}(q) may be expressed by the following equation:

$${γ}_{l}^{{n}_{t}} ( q ) = [ {\int }_{- {f}_{d}}^{{f}_{d}} {P}_{l , {n}_{t}} ( f ) {e}^{j2π f τ} d f ] {\vert}_{τ = {T}_{sa} q} \qquad eq . ( 2 )$$

In equation (2), the terms f_{d} may denote the peak Doppler frequency of all the channels 30.

In this example embodiment, different channel paths of each of the channels 30 may have arbitrary and different fading, thus each different channel path of each of the channels 30 may have a different normalized Doppler PSD P_{l,n}_{ₜ}(f). In addition, the normalized Doppler PSD P_{l,n}_{ₜ}(f) of each channel path of each of the channels 30 may be asymmetric about the zero frequency (e.g., f=0).

On the other hand, regarding the receiver side, the receiver 20 may be configured to receive signals from all of the transmitters 10. The signal received by the receiver 20 may be denoted as yₙ with “n” denoting the discrete time index. The received signal yₙ may include contributions from all the transmitted signals {xₙⁿ^{_{t}|}}_{∀n}_{ₜ}_{∈(1,2, . . . ,N}_{ₜ}₎ by all the transmitters 10. Accordingly, the received signal yₙ may be also defined as “composite received signal” (being composite of contributions from all the transmitted signals {xₙⁿ^{_{t}|}}_{∀n}_{ₜ}_{∈(1,2, . . . ,N}_{ₜ}₎ and noise) and expressed by the following equation:

$${y}_{n} = {\sum }_{{n}_{t} = 1}^{{N}_{t}} {\sum }_{l = 0}^{L - 1} {h}_{n , l}^{{n}_{t}} {x}_{n - l}^{{n}_{t}} + {w}_{n} \qquad eq . ( 3 )$$

In equation (3), “L” denotes the number of multipaths of each of the channels 30, and wₙ denotes a complex additive noise at time n.

In this example embodiment, the cyclic prefix (CP) may be capable of covering the maximum possible length of channel impulse response of each of the channels 30 (wherein, the maximum possible length of the channel impulse response may be denoted as “LTₛₐ” with “Tₛₐ” denoting the sampling period for the transmitted signal xₙⁿ^{ₜ} and the received signal yₙ). Moreover, in this example embodiment, each of the transmitters 10 and the receiver 20 of the cooperative OFDM communication system 1 may be configured to operate with a discrete Fourier transform (DFT) size of “N”. In order not to over-burden the mathematical notation, hereinafter, all integer indexes to frequency-domain quantities are to be understood as modulo-N. For example, l means l%N when indexing a frequency-domain quantity and (m−k) means (m−k)%N when indexing a frequency-domain quantity, where “%” denotes modulo operation in the sense that “a%N” for any integer a means taking the nonnegative remainder of integer division of a by N, that is, a%N=a−└a/N┘N where “└ ┘” is the floor operation that outputs the largest integer equal to or smaller than its argument. Accordingly, as expressed in the DFT domain, the composite received signal yₙ may be expressed by the following equation:

$${Y}_{m} = {\sum }_{{n}_{t} = 1}^{{N}_{t}} {\sum }_{k = 0}^{N - 1} {\sum }_{l = 0}^{L - 1} {X}_{k}^{{n}_{t}} {H}_{l , {n}_{t}}^{( m - k )} {e}^{\frac{- j 2 π lk}{N}} + {W}_{m} \qquad eq . ( 4 )$$

In equation (4), the terms Yₘ, Xₖⁿ^{ₜ}, Wₘ_{ₜ} and H_{l,n}_{ₜ}^{(m-k)} may be defined as the following:

Yₘ with a subcarrier index “m” may denote the DFT of the received signal yₙ (e.g., Yₘ=DFT(yₙ)),

Xₖⁿ^{ₜ} with a subcarrier index “k” may denote the DFT of the transmitted signal xₙⁿ^{ₜ} from the transmitter 10nₜ (e.g., Xₖⁿ^{ₜ}=DFT (xₙⁿ^{ₜ})),

Wₘ with the subcarrier index “m” may denote the DFT of the complex additive noise wₙ (e.g., Wₘ=DFT(wₙ)), and

H_{l,n}_{ₜ}^{(m-k)} with the subcarrier indexes “k” and “m” may denote frequency spreading function of the l-th channel path of the channel 30nₜ which corresponds to the transmitter 10nₜ.

Furthermore, the frequency spreading function H_{l,n}_{ₜ}^{(m-k)} may be expressed by the following equation, given that the subcarrier index “(m−k)” is replaced by the subcarrier index “k”:

$${H}_{l , {n}_{t}}^{( k )} = \frac{1}{N} {\sum }_{n = 0}^{N - 1} {h}_{n , l}^{{n}_{t}} {e}^{- j 2 π \frac{nk}{N}} \qquad eq . ( 5 )$$

Moreover, expanding the subcarrier index “m” in equation (4) to “[0,N−1]”, a set of received signal {Yₘ|_{m∈[0,N-1]}} in the DFT domain (also defined as a set of “frequency domain received signals {Yₘ}”) may be expressed in matrix-vector form as the following equation:

$$Y = {\sum }_{{n}_{t} = 1}^{{N}_{t}} {H}^{ {n}_{t}} {X}^{{n}_{t}} + W \qquad eq . ( 6 )$$

In equation (6), the terms Y, Hⁿ^{ₜ}, Xⁿ^{ₜ} and W may be defined as the following:

Y=[Y₀, Y₁, . . . , Y_{N-1}]′, which denote a vector form of the set of frequency domain received signals {Yₘ} corresponding to the subcarrier indexed “0” up to the subcarrier indexed “N−1,”

Xⁿ^{ₜ}=[X₀ⁿ^{ₜ}, X₁ⁿ^{ₜ}, . . . , X_{N-1}ⁿ^{ₜ}]′, which denote a vector form of a set of frequency domain transmitted signals {Xₖⁿ^{ₜ}} from the transmitter 10nₜ, which correspond to the subcarrier indexed “0” up to the subcarrier indexed “N−1,” and

W=[W₀, W₁, . . . , W_{N-1}]′, which denote a vector form of a set of frequency domain complex additive noise {Wₘ} corresponding to the subcarrier indexed “0” up to the subcarrier indexed “N−1.”

In the vector forms of Y, Xⁿ^{ₜ} and W defined as the above, the symbol “/” denotes the matrix-vector transpose. Furthermore, Hⁿ^{ₜ} may be defined as a “channel matrix” of the channel 30nₜ corresponding to the transmitter 10nₜ, which may have a size of N×N and expressed as the following:

$${H}^{{n}_{t}} = [ \begin{matrix}{a}_{0 , 0}^{{n}_{t}} & {a}_{0 , 1}^{{n}_{t}} & ⋮ & {a}_{0 , k}^{{n}_{t}} & ⋮ & ⋮ & ⋮ & {a}_{0 , N - 1}^{{n}_{t}} \\ {a}_{1 , 0}^{{n}_{t}} & {a}_{1 , 1}^{{n}_{t}} & ⋮ & ⋮ & ⋮ & ⋮ & ⋮ & ⋮ \\ {a}_{2 , 0}^{{n}_{t}} & {a}_{2 , 1}^{{n}_{t}} & ⋮ & ⋮ & ⋮ & ⋮ & ⋮ & ⋮ \\ ⋮ & ⋮ & ⋮ & ⋮ & ⋮ & ⋮ & ⋮ & ⋮ \\ {a}_{m , 0}^{{n}_{t}} & ⋮ & ⋮ & {a}_{m . k}^{{n}_{t}} & ⋮ & ⋮ & ⋮ & {a}_{m , N - 1}^{{n}_{t}} \\ ⋮ & ⋮ & ⋮ & ⋮ & ⋮ & ⋮ & ⋮ & ⋮ \\ ⋮ & ⋮ & ⋮ & ⋮ & ⋮ & ⋮ & {a}_{N - 2 , N - 2}^{{n}_{t}} & ⋮ \\ {a}_{N - 1 , 0}^{{n}_{t}} & ⋮ & ⋮ & {a}_{N - 1 , k}^{{n}_{t}} & ⋮ & ⋮ & ⋮ & {a}_{N - 1 , N - 1}^{{n}_{t}}\end{matrix} ] \qquad eq . ( 7 )$$

In equation (7), each of the entities {a_{m,k}ⁿ^{ₜ}} of the channel matrix Hⁿ^{ₜ} may be defined as a “channel coefficient.” The channel coefficient a_{m,k}ⁿ^{ₜ} may direct to a coefficient associated with a contribution on the frequency domain received signal Yₘ corresponding to the subcarrier indexed “m”, which is induced by the frequency domain transmitted signal Xₖⁿ^{ₜ} corresponding to the subcarrier indexed “k” from the transmitter 10nₜ. The contribution of Xₖⁿ^{ₜ} in Yₘ through a_{m,k}ⁿ^{ₜ} for k≠m is commonly considered as ICI. Such “ICI contributions” may be caused by uncorrected CFOs and Doppler shifts or Doppler spread due to time-variation of the channels 30. The channel coefficient a_{m,k}ⁿ^{ₜ} may be described by the following equation:

$${a}_{m , k}^{{n}_{t}} = {\sum }_{l = 0}^{L - 1} {H}_{l , {n}_{t}}^{( m - k )} {e}^{- j 2 π \frac{kl}{N}} \qquad eq . ( 8 )$$

Provided the channel coefficients {a_{m,k}ⁿ^{ₜ}}, the frequency domain received signal Yₘ corresponding to the subcarrier indexed “m” may be alternatively expressed in terms of the channel coefficients {a_{m,k}ⁿ^{ₜ}} and the frequency domain transmitted signals {Xₖⁿ^{ₜ}}, as the following equation:

$${Y}_{m} = {\sum }_{{n}_{t} = 1}^{{N}_{t}} {\sum }_{k = 0}^{N - 1} {a}_{m , k}^{{n}_{t}} {X}_{k}^{{n}_{t}} + {W}_{m} \qquad eq . ( 9 )$$

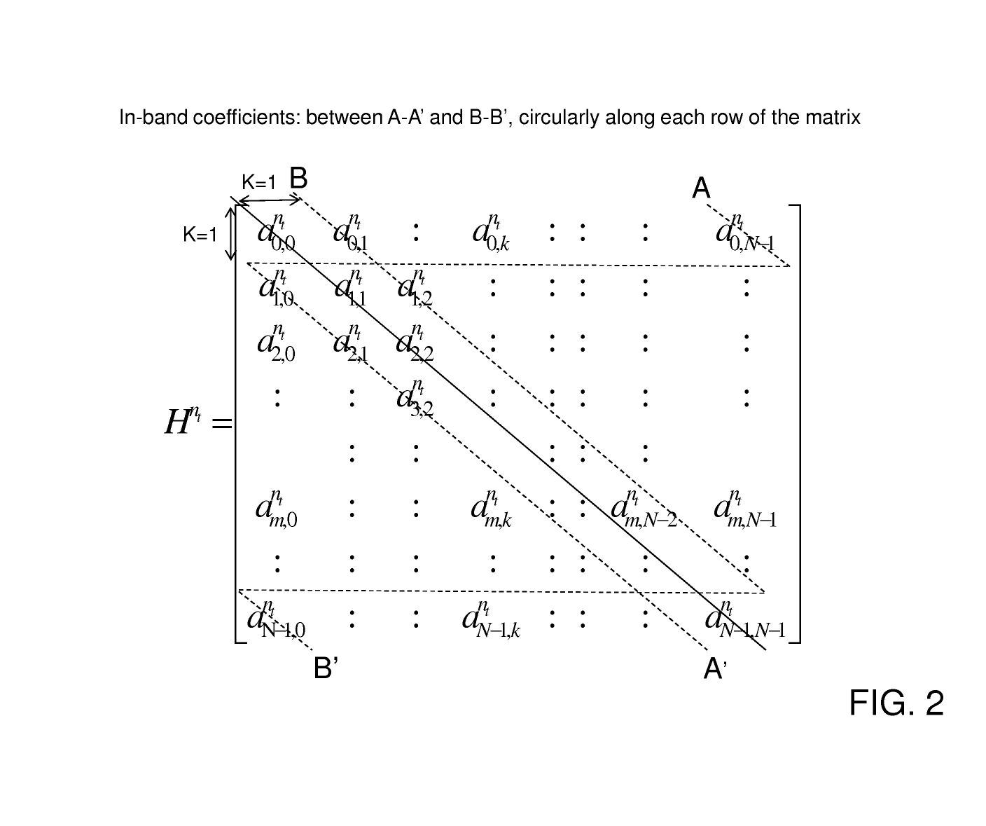

In this example embodiment, the receiver 20 may be configured to perform a receiver-based and frequency-domain signal processing to mitigate the effects of MCFO and ICI induced on the frequency domain received signals {Yₘ}. The mentioned “receiver-based” processing may direct to a non-closed-loop MCFO controlling scheme in which the transmitters 10 may not be requested by the receiver 20 to adjust carrier frequencies thereof. Furthermore, in order to reduce the computation complexity for the receiver 20, the mentioned receiver-based and frequency-domain signal processing may be executed under a condition that the receiver 20 may not have full space-frequency channel state information (CSI) of the channels 30. That is, the receiver 20 may not need to estimate all entities {a_{m,k}ⁿ^{_{t}|}}ₙ_{ₜ}_{∈[1,N}_{₁}_{]} of the channel matrix Hⁿ^{_{t|}}ₙ_{ₜ}_{∈[1,N}_{₁}_{]} for all the channels 30 corresponding to all the transmitters 10. Instead, the receiver 20 may have only “partial” CSI of each of the channels 30, wherein only selected entities {a_{m,k}ⁿ^{ₜ}} need to be estimated by the receiver 20, as will be discussed in the following paragraphs by reference to FIG. 2.

FIG. 2 illustrates the channel matrix Hⁿ^{ₜ} of the channel 30nₜ in the cooperative OFDM communication system 1 illustrated in FIG. 1 in accordance with an example embodiment. Referring to FIG. 2, a “band approximation” with a bandwidth “K” may be applied to the channel matrix Hⁿ^{ₜ}, and selected entities {a_{m,k}ⁿ^{_{t}|}}_{k∈[m-K,M+K]} residing within such a “band” may be defined as “in-band coefficients.” In this example embodiment, the channel matrix Hⁿ^{ₜ} may be band-approximated with bandwidth K=1, and the in-band coefficients may thus include entities {a_{m,k}ⁿ^{_{t}|}}_{k∈[m-1,m+1]} residing on and within the band defined by the dotted-lines A-A′ and B-B′, circularly in an end-around fashion along each row of the channel matrix as illustrated in FIG. 2. On the other hand, the remaining entities {a_{m,k}ⁿ^{_{t}|}}_{k∉[m-1,m+1]} of the channel matrix Hⁿ^{ₜ} other than the in-band coefficients may be defined as “out-of-band ICI coefficients”. Given the above definitions for the in-band coefficients and out-of-band ICI coefficients, the frequency domain received signal Yₘ obtained by equation (9) may be separated into an “in-band portion” and an “out-of-band portion” as following:

$${Y}_{m} = {\sum }_{{n}_{t} = 1}^{{N}_{t}} {\sum }_{k = m - K}^{m + K} {a}_{m , k}^{{n}_{t}} {X}_{k}^{{n}_{t}} + {\sum }_{{n}_{t} = 1 k ∉ [ m - K , m + K ]} {a}_{m , k}^{{n}_{t}} {X}_{k}^{{n}_{t}} + {W}_{m} \qquad eq . ( 10 )$$

In equation (10), the in-band portion

$${\sum }_{ {n}_{t} = 1}^{{N}_{t}} {\sum }_{k = m - K}^{m + K} {a}_{m , k}^{{n}_{t}} {X}_{k}^{{n}_{t}}$$

may direct to in-band contributions on the received signal Yₘ corresponding to the subcarrier indexed “m”, which are contributed by all the transmitted signals X_{m-K}ⁿ^{ₜ}, X_{m-K+1}ⁿ^{ₜ}, X_{m-K+2}ⁿ^{ₜ}, . . . , X_{m+K}ⁿ^{ₜ} from all the transmitters 10. Therefore, the in-band portion

$${\sum }_{ {n}_{t} = 1}^{{N}_{t}} {\sum }_{k = m - K}^{m + K} {a}_{m , k}^{{n}_{t}} {X}_{k}^{{n}_{t}}$$

may be also defined as “composite in-band signal,” which may be composite of all contributions from the transmitted signals X_{m-K}ⁿ^{ₜ}, X_{m-K+1}ⁿ^{ₜ}, X_{m-K+2}ⁿ^{ₜ}, . . . , X_{m+K}ⁿ^{ₜ} by all of the transmitters 10. On the other hand, the out-of-band portion

$${\sum }_{{n}_{t} = 1}^{{N}_{t}} {\sum }_{k ∉ [ m - K , m + K ]} {a}_{m , k}^{{n}_{t}} {X}_{k}^{{n}_{t}}$$

may be defined as “composite residual ICI,” which may be composite of all contributions from the transmitted signals X₀ⁿ^{ₜ}, X₁ⁿ^{ₜ}, . . . , X_{m-K-1}ⁿ^{ₜ}, X_{m+K+1}ⁿ^{ₜ}, . . . , X_{N-1}ⁿ^{ₜ}, X_{N}ⁿ^{ₜ} by all of the transmitters 10.

In one example, the receiver 20 may be configured to perform channel estimation to estimate the in-band coefficients {a_{m,k}ⁿ^{_{t}|}}_{k∈[m-K,m+K]}. Furthermore, based on the estimated in-band coefficients, the receiver 20 may be configured to perform frequency-domain equalizing on the composite in-band signal of the frequency domain received signal Yₘ and leave the composite residual ICI causing performance floors. In another example, signal detection may be performed on the frequency domain received signal Yₘ regarding only the composite in-band signal, wherein performance floors may be caused by the composite residual ICI as well.

Thanks to the statistical property of the composite residual ICI in the cooperative OFDM communication system 1 (that is, the normalized autocorrelation of the composite residual ICI may be substantially invariant with respect to various system settings and channel conditions, and the first few lags of the normalized autocorrelation function of the composite residual ICI may have relatively high values given that {Xⁿ^{_{t|}}ₙ_{ₜ}_{∈[1,N}_{ₜ}_{]}} are equal or independent), the composite residual ICI may be performed by a “whitening process” substantially independent to the properties of the channels 30 and system settings of the cooperative OFDM communication system 1. Such a whitening process may lower the performance floors caused by the composite residual ICI.

In operation, the whitening process may be performed on the frequency domain received signal Yₘ. Thereby, the whitening process may be also performed on the sum of the composite residual ICI

$${\sum }_{{n}_{t} = 1}^{{N}_{t}} {\sum }_{k ∉ [ m - K , m + K ]} {a}_{m , k}^{{n}_{t}} {X}_{k}^{{n}_{t}}$$

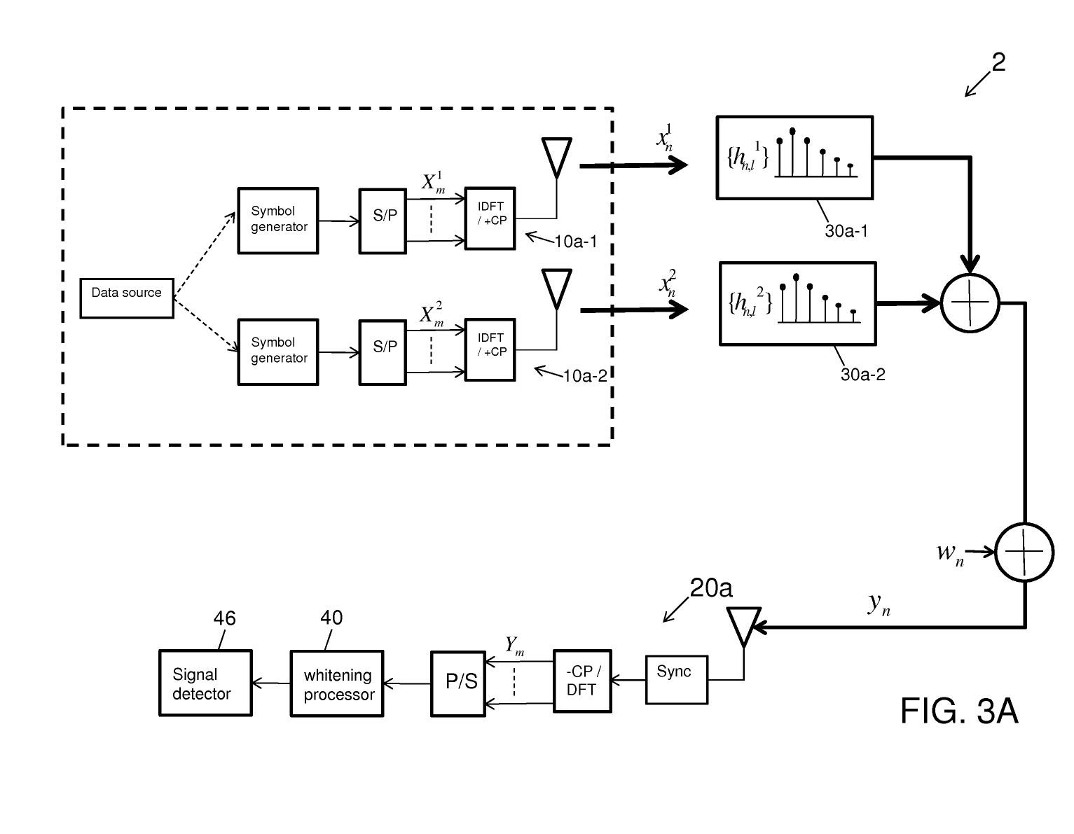

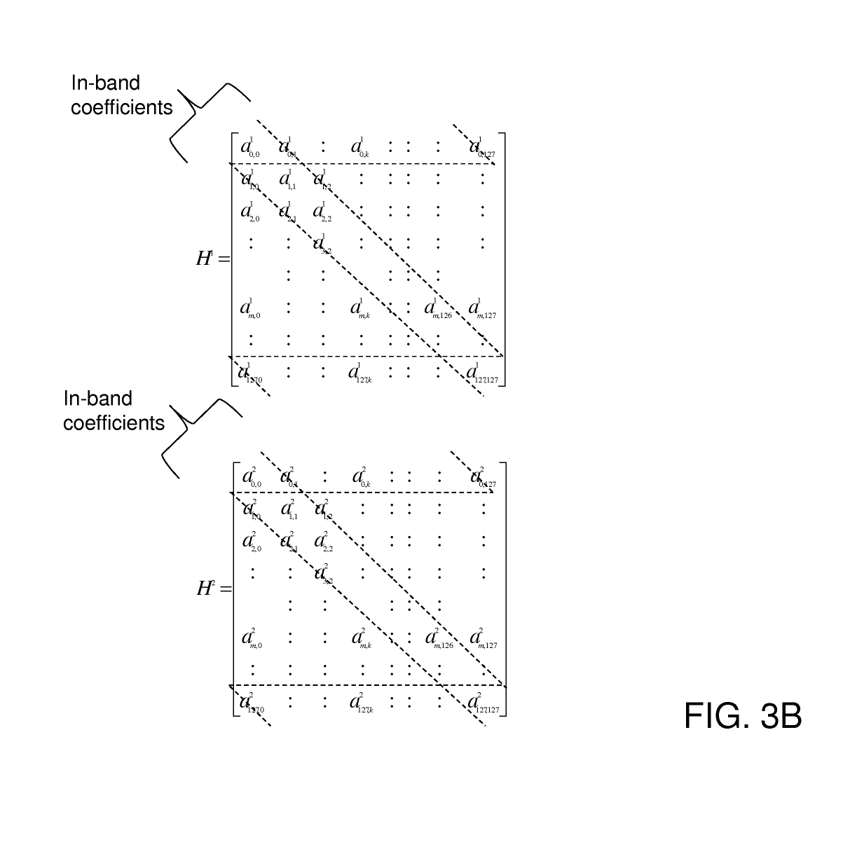

and the channel noise Wₘ within the frequency domain received signal Yₘ. Wherein, the whitened received signal may be denoted as “Yₘ”. Furthermore, subsequent to the whitening process, the receiver 20 may be configured to perform signal detection on the whitened received signal \tilde{Y}ₘ so as to detect data (e.g., bit information) conveyed in the transmitted signals Xₘⁿ^{ₜ} by all the transmitters 10. Detailed operation of the whitening process will be discussed with the aid of an example embodiment described in the following paragraphs by reference to FIGS. 3A and 3B. In the following example embodiment, for simplicity, a cooperative OFDM communication system including two transmitters (Nₜ=2) is considered.

FIG. 3A is a block diagram of the baseband part of a cooperative OFDM communication system 2 in accordance with another example embodiment, and FIG. 3B illustrates channel matrices H¹ and H² of the channels 30a-1 and 30a-2 in the cooperative OFDM communication system 2 illustrated in FIG. 3A in accordance with another example embodiment. Referring to FIG. 3A, the cooperative OFDM communication system 2 may be similar to the cooperative OFDM communication system 1 as illustrated in FIG. 1 except that, the cooperative OFDM communication system 2 may include but not limited to two transmitters 10a-1 and 10a-2. Furthermore, the cooperative OFDM communication system 2 may operate with but not limited to a DFT size of 128, which corresponds to 128 subcarriers (e.g., subcarrier indexed “0” up to subcarrier indexed “127”).

The transmitters 10a-1 and 10a-2 may be communicatively coupled to a receiver 20a through channels 30a-1 and 30a-2 respectively, and the transmitters 10a-1 and 10a-2 may be configured to transmit signals to the receiver 20a through the channels 30a-1 and 30a-2 respectively. Specifically, the signal transmitted by the transmitter 10a-1 may be denoted as X¹, while the signal transmitted by the transmitter 10a-2 may be denoted as xₙ². Furthermore, the channel 30a-1 may be characterized by a set of discrete-time complex gains {h_{n,l}¹}, while the channel 30a-2 may be characterized by a set of discrete-time complex gains {h_{n,l}²}. In this example embodiment, each of the channels 30a-1 and 30a-2 may have but not limited to six channel paths. The signals xₙ¹ and xₙ² which may be convolved with the complex gains {h_{n,l}¹} and {h_{n,l}²} respectively, may then be received by the receiver 20a. The received signal at the receiver 20a may be denoted as yₙ, and the received signal yₙ may be expressed by the following equation (wherein channel noise wₙ may be included):

$${y}_{n} = {\sum }_{l = 0}^{5} {h}_{n , l}^{1} {x}_{n - l}^{1} + {\sum }_{l = 0}^{5} {h}_{n , l}^{2} {x}_{n - l}^{2} + {w}_{n} \qquad eq . ( 11 )$$

Moreover, being transformed to the DFT domain, the frequency domain received signal Yₘ which corresponds to subcarrier indexed “m,” may be expressed in terms of frequency domain transmitted signals “Xₖ¹” and “Xₖ²”, frequency domain complex additive noise “Wₘ” and frequency spreading functions “H_{l,1}^{(m-k)}” (and “H_{l,2}^{(m-k)}” of the l-th channel path of the channels 30a-1 and 30a-2, as the following equation:

$${Y}_{m} = {\sum }_{k = 0}^{127} {\sum }_{l = 0}^{5} {X}_{k}^{1} {H}_{l , 1}^{( m - k )} {e}^{\frac{- j 2 π lk}{128}} + {\sum }_{k = 0}^{127} {\sum }_{l = 0}^{5} {X}_{k}^{2} {H}_{l , 2}^{( m - k )} {e}^{\frac{- j 2 π lk}{128}} + {W}_{m} \qquad eq . ( 12 )$$

In addition, to be expressed in matrix-vector forms, equation (12) may be expressed as the following:

Y=H¹X¹+H²X²+W eq. (13)

In equation (13), the set of frequency domain received signals {Yₘ}|_{m∈[0,127]} which correspond to the subcarrier indexed “0” up to the subcarrier indexed “127,” may be expressed in a vector form of Y=[Y₀, Y₁, . . . , Y₁₂₇]′. Furthermore, the set of frequency domain transmitted signals {Xₖ¹}|_{k∈[0,127]} from the transmitter 10a-1 that correspond to the subcarrier indexed “0” up to the subcarrier indexed “127,” may be expressed in a vector form of X¹=[X₀¹, X₁¹, . . . , X₁₂₇¹]′. Likewise, the set of frequency domain transmitted signals {Xₖ²}|_{k∈[0,127]} from the transmitter 10a-2 that correspond to the subcarrier indexed “0” up to the subcarrier indexed “127,” may be expressed in a vector form of X²=[X₀², X₁², . . . , X₁₂₇²]′. In the same manner, the set of frequency domain complex additive noise {Wₘ}|_{m∈[0,127]} that correspond to the subcarrier indexed “0” up to the subcarrier indexed “127,” may be expressed in a vector form of W=[W₀, W₁, . . . , W₁₂₇]′.

On the other hand, the channel matrices H¹ and H² in equation (13) may have a size of 128×128 with channel coefficients {a_{m,k}¹}|_{m,k∈[0,127]} and {a_{m,k}²}|_{m,k∈[0,127]} as their entities. The channel coefficients {a_{m,k}¹}|_{m,k∈[0,127]} and {a_{m,k}²}|_{m,k∈[0,127]} may be described using the following equations:

$$\begin{matrix}{a}_{m , k}^{1} = {\sum }_{l = 0}^{5} {H}_{l , 1}^{( m - k )} {e}^{- j 2 π \frac{kl}{128}} \\ and & eq . ( 14 ) \\ {a}_{m , k}^{2} = {\sum }_{l = 0}^{5} {H}_{l , 2}^{( m - k )} {e}^{- j 2 π \frac{kl}{128}} & eq . ( 15 )\end{matrix}$$

In this example embodiment, the cooperative OFDM communication system 2 may have a bandwidth K=1 (e.g., the channel matrices H¹ and H² may thus be band-approximated with bandwidth K=1), hence, the entities {a_{m,k}¹}|_{m,k∈[0,127]} and {a_{m,k}²}|_{m,k∈[0,127]} of the channel matrices H¹ and H² may be categorized as the in-band coefficients and the out-of-band coefficients as shown in FIG. 3B. Based on the above categorization, the receiver 20a may be configured to perform whitening process on the composite residual ICI

$${\sum }_{k ∉ [ m - 1 , m + 1 ]} ( {a}_{m , k}^{1} {X}_{k}^{1} + {a}_{m , k}^{2} {X}_{k}^{2} )$$

contributed from the transmitters 10a-1 and 10a-2. Meanwhile, such a whitening process may be also performed on the channel noise Wₘ.

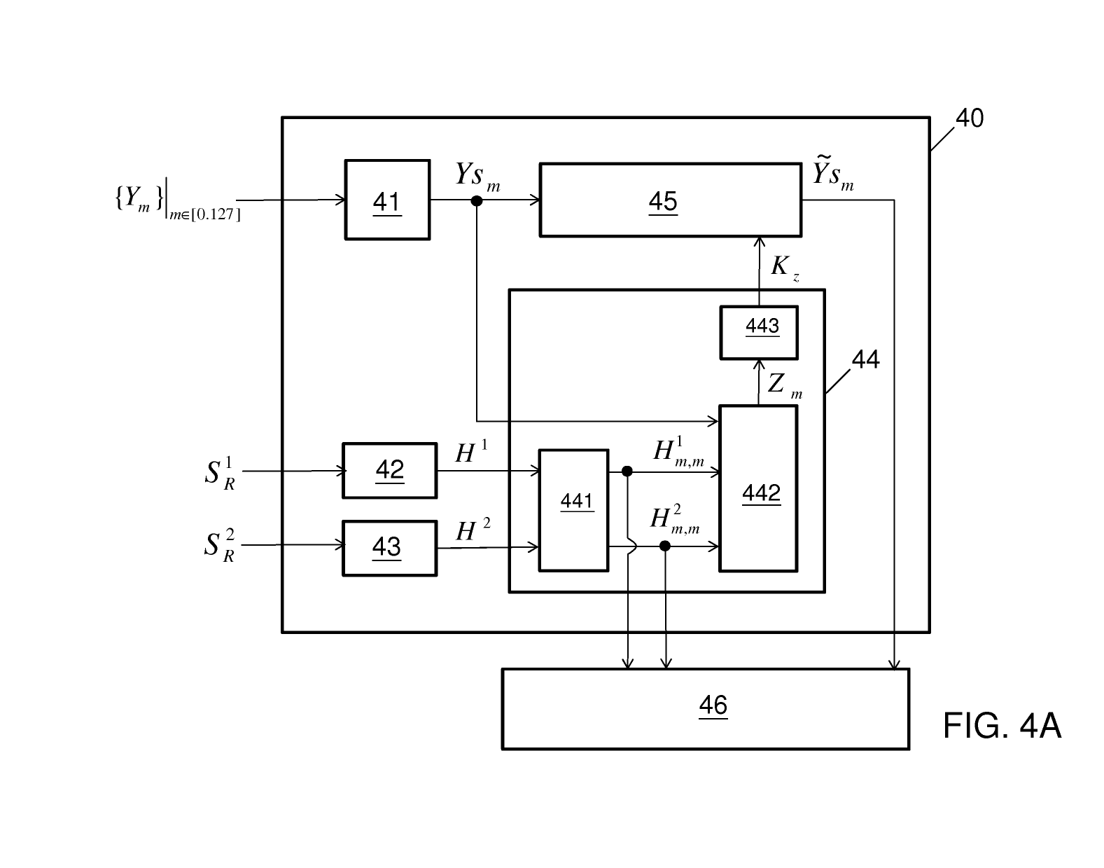

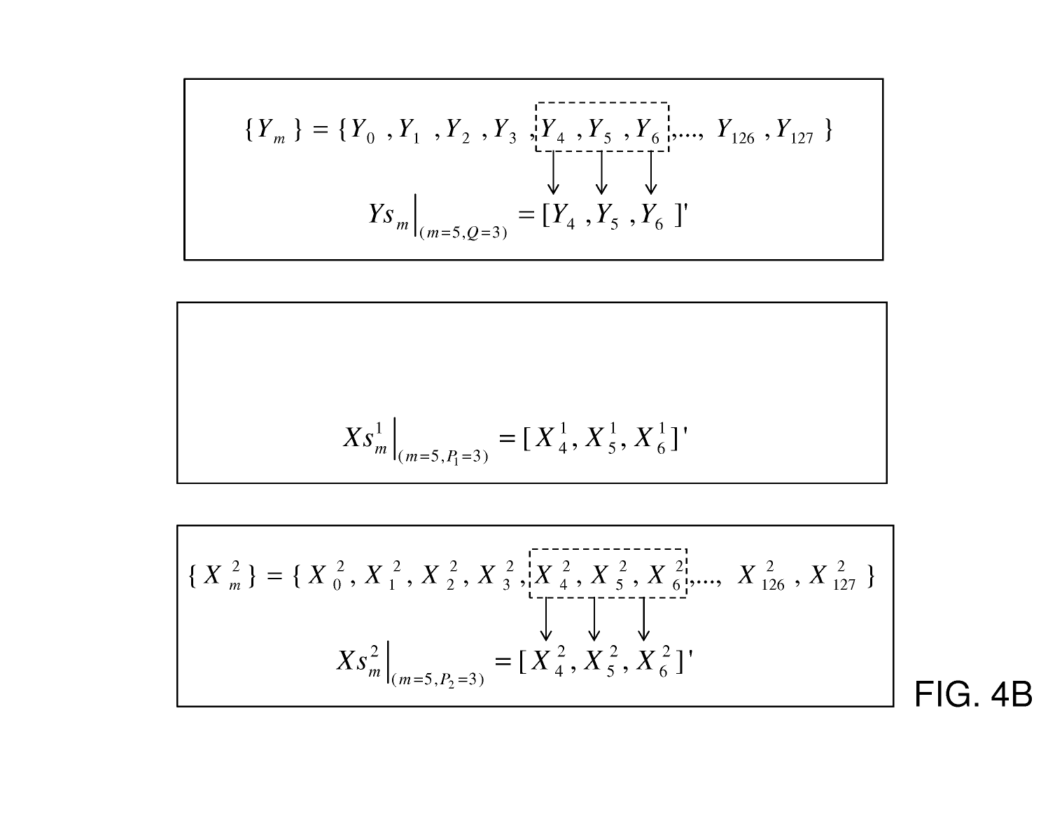

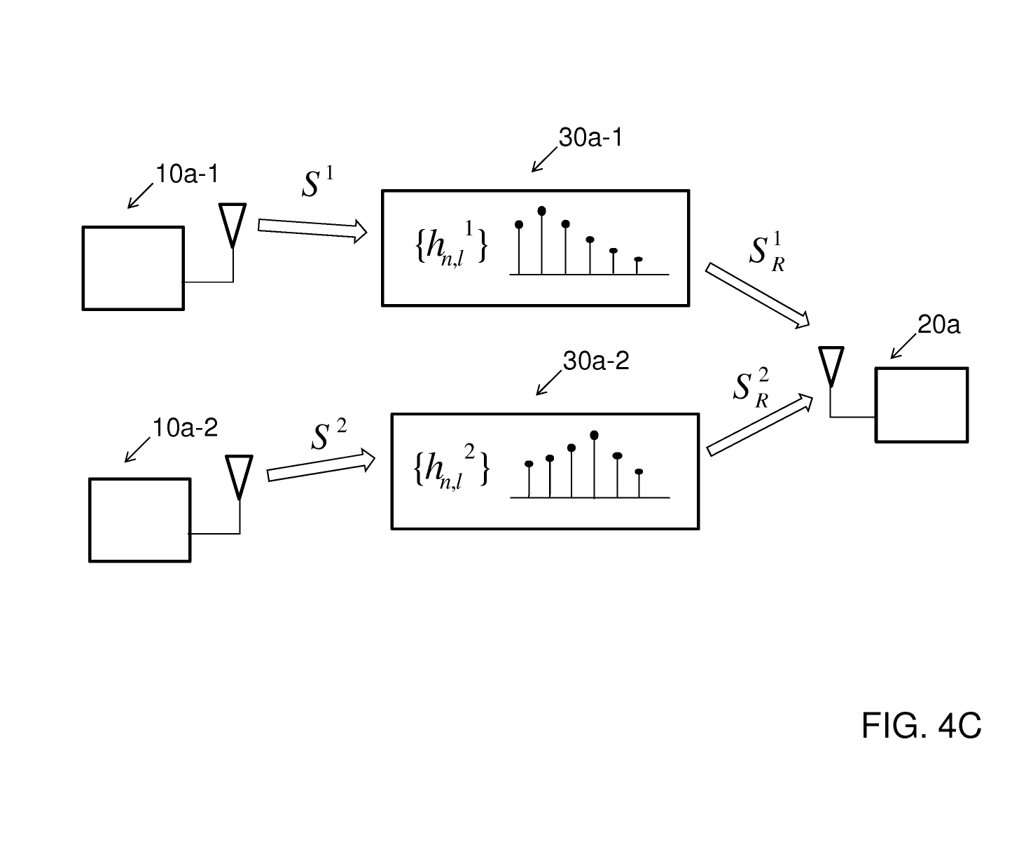

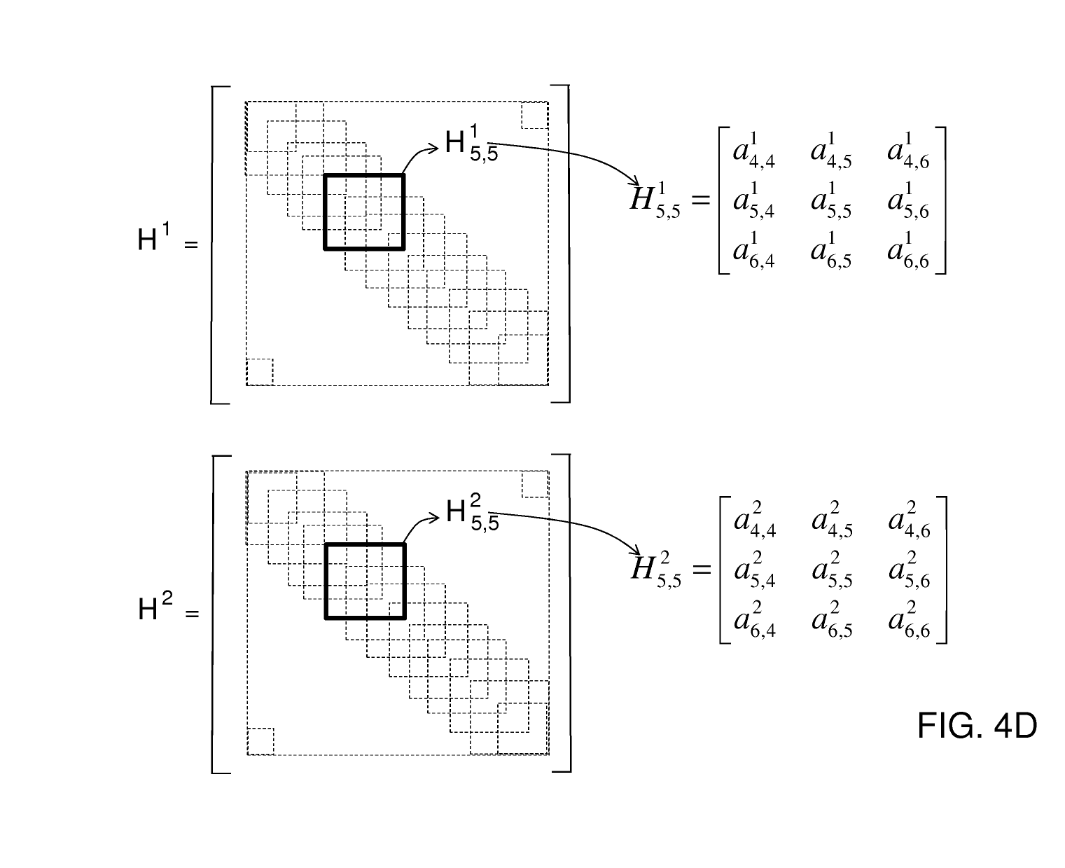

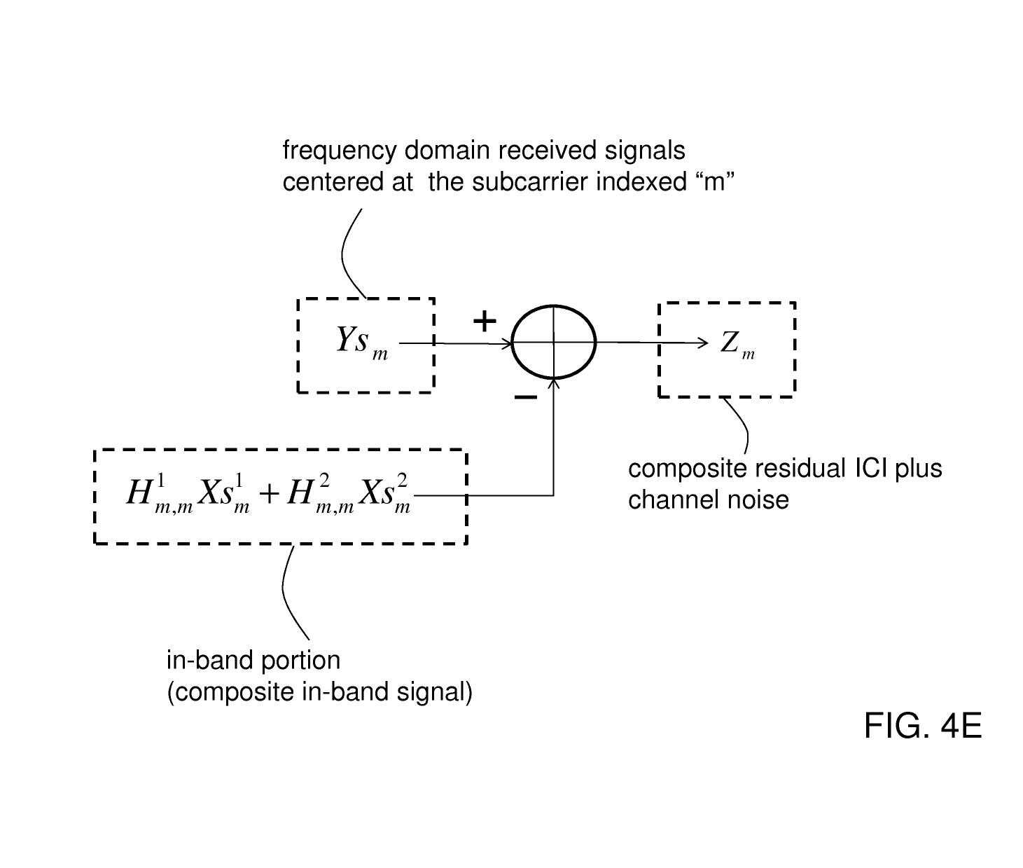

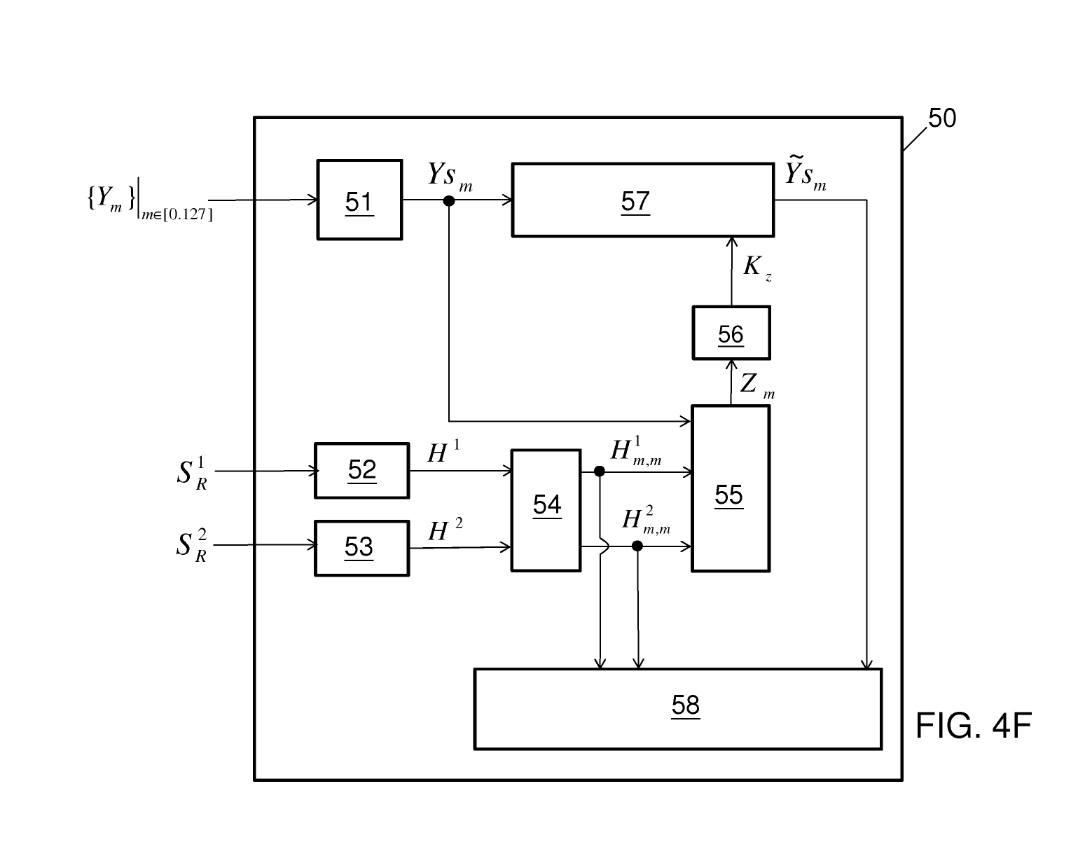

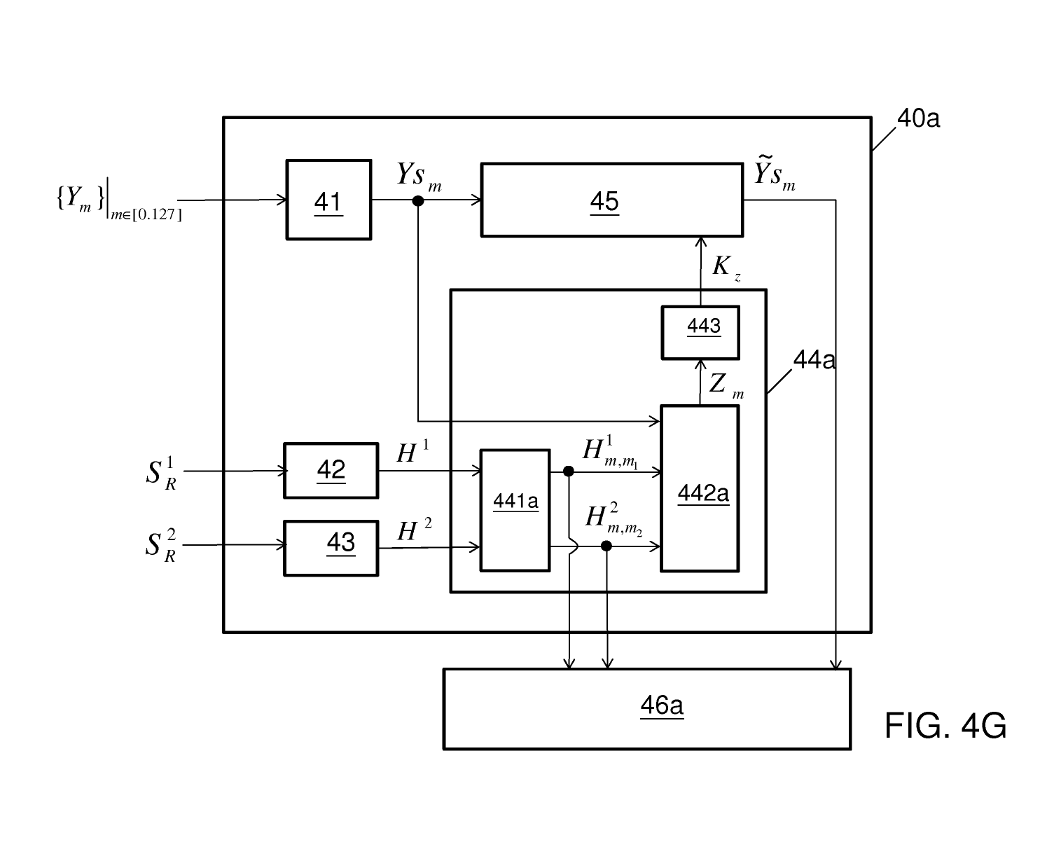

In order to reduce computation complexity, in this example embodiment, the whitening process may be performed block-by-block (thus defined as “blockwise whitening process”) with each block corresponding to several selected subcarriers, instead of whole sequence corresponding to all the 128 subcarriers. The receiver 20a may include a device to perform such a blockwise whitening process. An exemplary hardware structure of such a device and exemplary operations thereof will be discussed in the following paragraphs by reference to FIGS. 4A to 4E.

FIG. 4A is a block diagram of a device 40 for performing the blockwise whitening process and a signal detector 46 in the cooperative OFDM communication system 2 illustrated in FIG. 3A in accordance with another example embodiment, and FIG. 4B illustrates the sub-vectors Ysₘ, Xsₘ¹ and Xsₘ² in the cooperative OFDM communication system 2 illustrated in FIG. 3A in accordance with another example embodiment. Referring to FIG. 4A, the device 40 which may be configured to perform the blockwise whitening process, may include a truncator 41, at least two channel estimators 42 and 43, a processor 44 and a filter 45.

The truncator 41 may be configured to receive the set of frequency domain received signals {Yₘ}|_{m∈[0,127]} in series, and truncate the set of frequency domain received signals {Yₘ}|_{m∈[0,127]} into sub-blocks (denoted as “sub-vectors {Ysₘ}”). The sub-vector Ysₘ may have a length “Q” and center at the subcarrier indexed “m.” That is, the sub-vector Ysₘ may include a subset of the frequency domain received signals

$$\{ {Y}_{m - ⌊ \frac{Q - 1}{2} ⌋} , … , {Y}_{m - 1} , {Y}_{m} , {Y}_{m + 1} , … , {Y}_{m + ⌈ \frac{Q - 1}{2} ⌉} \}$$

near the subcarrier indexed “m” where “┌ ┐” denotes the ceiling operation that outputs the smallest integer equal to or greater than its argument. In this example embodiment, the sub-vector Ysₘ having a length Q=3 and centering at the subcarrier indexed “5” may be expressed in vector form of [Y₄, Y₅, Y₆]′ as shown in FIG. 4B.

Likewise, the set of frequency domain transmitted signals {Xₘ¹}|_{m∈[0,127]} from the transmitter 10a-1 and the set of frequency domain transmitted signals {Xₘ²}|_{m∈[0,127]} from the transmitter 10a-2 may be also truncated into sub-blocks (denoted as “sub-vectors {Xsₘ¹} and {Xsₘ²}”) respectively. Each of the sub-vectors Xsₘ¹ and Xsₘ² may have a length “P₁” and “P₂” respectively and center at the subcarrier indexed “m”. As shown in FIG. 4B, the sub-vectors Xsₘ¹ and Xsₘ² having a length P₁=P₂=3 and centering at the subcarrier indexed “5” may be expressed in vector form of [X₄¹, X₅¹, X₆¹]′ and [X₄², X₅²,X₆²]′ respectively. Furthermore, in this example embodiment, the sub-vectors Ysₘ, Xsₘ¹ and Xsₘ² may not be limited to have equal length.

Referring back to FIG. 4A, the channel estimators 42 and 43 may be configured to estimate channel state information of the channels 30a-1 and 30a-2 respectively. Based on the estimated channel state information, channel coefficients corresponding to the channels 30a-1 and 30a-2 may be obtained. Thereafter, the channel matrices H¹ and H² which correspond to the channels 30a-1 and 30a-2 respectively may be constructed using the obtained channel coefficients as their entities. In one example embodiment, the channel state information of the channels 30a-1 and 30a-2 may be estimated by the channel estimators 42 and 43 exploiting a channel sounding method.

FIG. 4C illustrates the channel sounding method performed by the channel estimators 42 and 43 illustrated in FIG. 4A in accordance with another example embodiment. Referring to FIG. 4C, the transmitter 10a-1 may be configured to transmit a sounding signal (which may alternatively be referred to as a pilot signal) S¹ through the channel 30a-1. The sounding signal S¹ may pass through the channel 30a-1 and thereafter received by the receiver 20a. The received sounding signal at the receiver 20a may be denoted as S_{R}¹, and channel state information of channel 30a-1 may be derived from the received sounding signal S_{R}¹. Likewise, the transmitter 10a-2 may be configured to transmit a sounding signal S² through the channel 30a-2, and channel state information of the channel 30a-2 may be derived from the received sounding signal S_{R}² at the receiver 20a. Referring back to FIG. 4A, the processor 44 may include computing units 441, 442 and 443. The computing unit 441 may be configured to decompose the channel matrices H¹ and H² into a plurality of sub-matrices {H_{m,m}¹} and {H_{m,m}²}, as will be discussed in the following paragraphs by reference to FIG. 4D.

FIG. 4D illustrates the channel matrices H¹ and H² of the channels 30a-1 and 30a-2 in the cooperative OFDM communication system 2 illustrated in FIG. 3A in accordance with an example embodiment, and FIG. 4E illustrates an operation for calculating composite residual ICI plus channel noise zₘ in the blockwise whitening process in accordance with an example embodiment. Referring to FIG. 4D, to fit the length Q of the sub-vector Ysₘ and the lengths P₁ and P₂ of the sub-vectors Xsₘ¹ and Xsₘ², the sub-matrices {H_{m,m}¹} and {H_{m,m}²} may have sizes Q×P₁ and Q×P₂, respectively. Furthermore, the sub-matrices H_{m,m}¹ and H_{m,m}² may correspond to the subcarrier indexed “m” and include channel coefficients residing near entities a_{m,m}¹ and a_{m,m}² respectively. For example, the sub-matrix H_{5,5}¹ which may have a size of 3×3 and correspond to the subcarrier indexed “5,” may include channel coefficients {a_{4,4}¹, a_{5,4}¹, a_{6,4}¹, a_{4,5}¹, a_{5,5}¹, a_{6,5}¹, a_{4,6}¹, a_{5,6}¹, a_{6,6}¹} as its entities. Likewise, the sub-matrix H_{5,5}² which may also have a size of 3×3 and correspond to the subcarrier indexed “5,” may include channel coefficients {a_{4,4}²,a_{5,4}²,a_{6,4}²,a_{4,5}²,a_{5,5}²,a_{6,5}²,a_{4,6}²,a_{5,6}²,a_{6,6}²} as its entities.

Providing the mentioned sub-vectors Xsₘ¹ and Xsₘ² and the mentioned sub-matrices H_{m,m}¹ and H_{m,m}², the sub-vector Ysₘ may be expressed by the following equation:

Ysₘ=H_{m,m}¹Xsₘ¹+H_{m,m}²Xsₘ²+zₘ eq. (16)

In equation (16), the portion H_{m,m}¹Xsₘ¹+H_{m,m}²Xsₘ² may include composite in-band contributions on the frequency domain received signals

$${Y}_{m - ⌊ \frac{Q - 1}{2} ⌋} , … , {Y}_{m - 1} , {Y}_{m} , {Y}_{m + 1} , … , and {Y}_{m + ⌈ \frac{Q - 1}{2} ⌉} ,$$

which are contributed by the frequency domain transmitted signals

$${X}_{m - ⌊ \frac{{P}_{1} - 1}{2} ⌋}^{1} , … , {X}_{m - 1}^{1} , {X}_{m}^{1} , {X}_{m + 1}^{1} , … , and {X}_{m + ⌈ \frac{{P}_{1} - 1}{2} ⌉}^{1}$$

from the transmitter 10a-1 and the frequency domain transmitted signals

$${X}_{m - ⌊ \frac{{P}_{2} - 1}{2} ⌋}^{2} , … , {X}_{m - 1}^{2} , {X}_{m}^{2} , {X}_{m + 1}^{2} , … , and {X}_{m + ⌈ \frac{{P}_{2} - 1}{2} ⌉}^{2}$$

from the transmitter 10a-2. On the other hand, the portion “zₘ” may include the channel noise and the composite residual ICI contributed by the transmitters 10a-1 and 10a-2 corresponding to the channels 30a-1 and 30a-2. More particularly, the portion zₘ may include all the remaining terms for the sub-vector Ysₘ in the right-hand-side (RHS) of equation (13), which are left out of the portion H_{m,m}¹Xsₘ¹+H_{m,m}²Xsₘ². Accordingly, the portion zₘ may be obtained by subtracting the portion H_{m,m}¹Xsₘ¹+H_{m,m}²Xsₘ² from the sub-vector Ysₘ, as illustrated in FIG. 4E. The operation shown in FIG. 4E may be executed by the computing unit 442 of the processor 44.

Furthermore, thanks to the statistical property of the composite residual ICI within the portion zₘ, the portion “zₘ” can be whitened in a nearly channel-independent manner. In this example embodiment, the portion “zₘ” may be whitened by performing the blockwise whitening process thereon. To perform the mentioned blockwise whitening process, covariance matrix (denoted as “K_{z}”) of the portion “zₘ” needs to be calculated in advance. In this example embodiment, the computing unit 443 of the processor 44 may be configured to execute an operation to calculate the covariance matrix K_{z} as the following:

K_{z}=E[zₘzₘ^{H}] eq. (17)

By the independence between the composite residual ICI and the channel noise, K_{z}=Kₗ+K_{w} where K_{w} is the Q×Q covariance matrix of the channel noise component in zₘ, and Kₗ is the Q×Q covariance matrix of the composite residual ICI component in zₘ. In one embodiment of this invention, K_{w} may be calculated by estimating the variance of the channel noise and letting K_{w} be a diagonal matrix with its diagonal terms equal to the variance of the channel noise, and Kₗ may be calculated by estimating the variance of the composite residual ICI and employing the statistical property of the composite residual ICI.

Moreover, referring back to FIG. 4A, the covariance matrix K_{z} may be provided to the filter 45, and the filter 45 (also denoted as “whitening filter”) may be configured to perform blockwise whitening process on the sub-vector Ysₘ and in turn the portion “zₘ”, using the following operation:

$$\tilde{Y} {s}_{m} = {K}_{z}^{- \frac{1}{2}} {Ys}_{m} \qquad eq . ( 18 )$$

In equation (18), the term \tilde{Y}sₘ denotes the whitened received signal. The whitened received signal \tilde{Y}sₘ may be further expanded as the following equation:

$$\tilde{Y} {s}_{m} = {K}_{z}^{- \frac{1}{2}} {H}_{m , m}^{1} {Xs}_{m}^{1} + {K}_{z}^{- \frac{1}{2}} {H}_{m , m}^{2} {Xs}_{m}^{2} + {K}_{z}^{- \frac{1}{2}} {z}_{m} = {\tilde{H}}_{m , m}^{1} {Xs}_{m}^{1} + {\tilde{H}}_{m , m}^{2} {Xs}_{m}^{2} + {\tilde{z}}_{m} \qquad eq . ( 19 )$$

In equation (19), the portion “\tilde{z}ₘ”denotes the whitened composite residual ICI plus channel noise.

Subsequent to the blockwise whitening process, the whitened received signal \tilde{Y}sₘ may be sent to a signal detector 46, and the signal detector 46 may be configured to detect the whitened received signal \tilde{Y}sₘ by various detection methods. In this example embodiment, the whitened received signal \tilde{Y}sₘ may be detected by a maximum-likelihood sequence estimation (MLSE)-based detection.

Regarding the above-mentioned MLSE-based detection performed on the whitened received signal \tilde{Y}sₘ, specifically, given that the whitened composite residual ICI plus channel noise \tilde{z}ₘ for all the subcarriers indexed “0” to “127” (e.g., 0≦m≦127) are mutually independent, the joint likelihood function of the whitened received signal \tilde{Y}sₘ for all the subcarriers indexed “0” to “127” (e.g., 0≦m≦127) may take a form of the following:

$$f ( \tilde{Y} {s}_{0} , \tilde{Y} {s}_{1} , … , \tilde{Y} {s}_{127} \vert {Xs}_{m}^{{n}_{t}} ; 0 \leq m \leq 127 , {n}_{t} ∈ [ 1 , 2 ] ) = f ( {\tilde{z}}_{0} , {\tilde{z}}_{1} , … , {\tilde{z}}_{127} ) = {\prod }_{n = 0}^{127} f ( {\tilde{z}}_{n} ) \qquad eq . ( 20 )$$

In case the above set of \tilde{z}ₘ are not mutually independent, equation (20) may still be used as a possibly approximate mathematical model to deal with \tilde{z}ₘ.

Accordingly, the log-likelihood functions Λₘ may be defined as the following:

Λₘ≡log f(\tilde{z}₀,\tilde{z}₁, . . . ,\tilde{z}ₘ) for 0≦m≦127 eq. (21)

Furthermore, the above log-likelihood functions Λₘ may have a recursive relation as the following:

Λₘ=Λₘ₋₁+log f(\tilde{Y}sₘ−\tilde{H}_{m,m}¹Xsₘ¹−\tilde{H}_{m,m}²Xsₘ²) for m≧1 eq. (22)

With the above recursive relation, trellis structure for Viterbi algorithm may be formed and applied to the signal detector 46 of the receiver 20a in this example embodiment.

In yet another example embodiment, the device 40 for performing the blockwise whitening process and the signal detector 46 for performing the signal detection may be integrated into a single device, as will be discussed in the following paragraphs by reference to FIG. 4F.

FIG. 4F is a block diagram of a device 50 for performing the blockwise whitening process and the signal detection in accordance with yet another example embodiment. Referring to FIG. 4F, the device 50 may include a processor or a micro control unit (MCU) which may be configured to execute computer-based instructions to perform the blockwise whitening process and the signal detection.

In this example embodiment, the device 50 may include computing units 51 to 58. The computing units 51 to 58 may correspond to the truncator 41, the channel estimators 42 and 43, the computing units 441, 442 and 443, the filter 45 and the signal detector 46 illustrated by FIG. 4A respectively. Specifically, the computing unit 51 may be configured to truncate the frequency domain received signals {Yₘ} into subvectors Ysₘ. Furthermore, the computing units 52 and 53 may be configured to estimate channel state information of the channels 30a-1 and 30a-2 and generate channel matrices H¹ and H². Moreover, the computing unit 54 may be configured to decompose the channel matrices H¹ and H² into sub-matrices H_{m,m}¹ and H_{m,m}². In addition, based on the subvectors Ysₘ and the sub-matrices H_{m,m}¹ and H_{m,m}², the computing unit 55 may be configured to calculate the portion zₘ which includes the composite residual ICI and the channel noise, and the computing unit 56 may be configured to calculate the covariance matrix K_{z} of the portion zₘ. Based on the covariance matrix K_{z}, the computing unit 57 may be configured to perform whitening process on the subvectors Ysₘ to obtain whitened received signal \tilde{Y}sₘ. Thereafter, the computing unit 58 may be configured to perform signal detection on the whitened received signal \tilde{Y}sₘ using a MLSE-based detection.

FIG. 4G is a block diagram of a device 40a for performing the blockwise whitening process and a device 46a for performing the signal detection in accordance with still another example embodiment. Referring to FIG. 4G, the device 40a may be similar to the device 40 illustrated in FIG. 4A except that, the computing unit 441a of the device 40a may be configured to decompose the channel matrices H¹ and H² into a plurality of sub-matrices {H_{m,m}_{₁}¹} and {H_{m,m}_{₂}²}.

More particularly, the sub-matrices {H_{m,m}_{₁}¹} and {H_{m,m}_{₂}²} may be similar to the sub-matrices {H_{m,m}¹} and {H_{m,m}²} expressed in equation (16) and illustrated by FIG. 4A except that H_{m,m}_{₁}¹ is defined as a Q×P₁ sub-matrix of H¹ consisting of the intersection of the

$${( m - ⌊ \frac{Q - 1}{2} ⌋ )}^{th}$$

to the

$${( m + ⌈ \frac{Q - 1}{2} ⌉ )}^{th}$$

rows of H¹ and the

$${( {m}_{1} - ⌊ \frac{{P}_{1} - 1}{2} ⌋ )}^{th}$$

to the

$${( {m}_{1} + ⌈ \frac{{P}_{1} - 1}{2} ⌉ )}^{th}$$

columns of H¹ but may have some elements therein set to zero and, on the other hand, H_{m,m}_{₂}² is defined as a Q×P₂ sub-matrix of H² consisting of the intersection of the

$${( m - ⌊ \frac{Q - 1}{2} ⌋ )}^{th}$$

to the

$${( m + ⌈ \frac{Q - 1}{2} ⌉ )}^{th}$$

rows of H² and the

$${( {m}_{2} - ⌊ \frac{{P}_{2} - 1}{2} ⌋ )}^{th}$$

to the

$${( {m}_{2} + ⌈ \frac{{P}_{2} - 1}{2} ⌉ )}^{th}$$

columns of H² but may have some elements therein set to zero. Given the above definitions of H_{m,m}_{₁}¹ and H_{m,m}_{₂}², equation (16) may be more generally organized into the following form:

Ysₘ=H_{m,m}_{₁}¹Xsₘ_{₁}¹+H_{m,m}_{₂}²Xsₘ_{₂}²+zₘ eq. (23)

In equation (23), Xsₘ_{₁}¹ is defined similarly to Xsₘ^{l} of equation (16) except that the subscript m thereof is substituted by m₁, and Xsₘ_{₂}² is defined similarly to Xsₘ² of equation (16) except that the subscript m thereof is substituted by m₂. Furthermore, zₘ includes all the remaining terms for the sub-vector Ysₘ in the RHS of equation (13) which are left out of the portion H_{m,m}_{₁}¹Xsₘ_{₁}¹+H_{m,m}_{₂}² Xsₘ_{₂}². Accordingly, in this example embodiment of the present invention, the computing unit 442a may be configured to calculate the portion zₘ by subtracting the portion H_{m,m}_{₁}¹Xsₘ_{₁}¹+H_{m,m}_{₂}²Xsₘ_{₂}² from the sub-vector Ysₘ.

Moreover, the detector 46a may be configured to perform signal detection (for example, MLSE detection) on the whitened received signal \tilde{Y}sₘ with the aid of sub-matrices H_{m,m}¹ and H_{m,m}_{₂}².

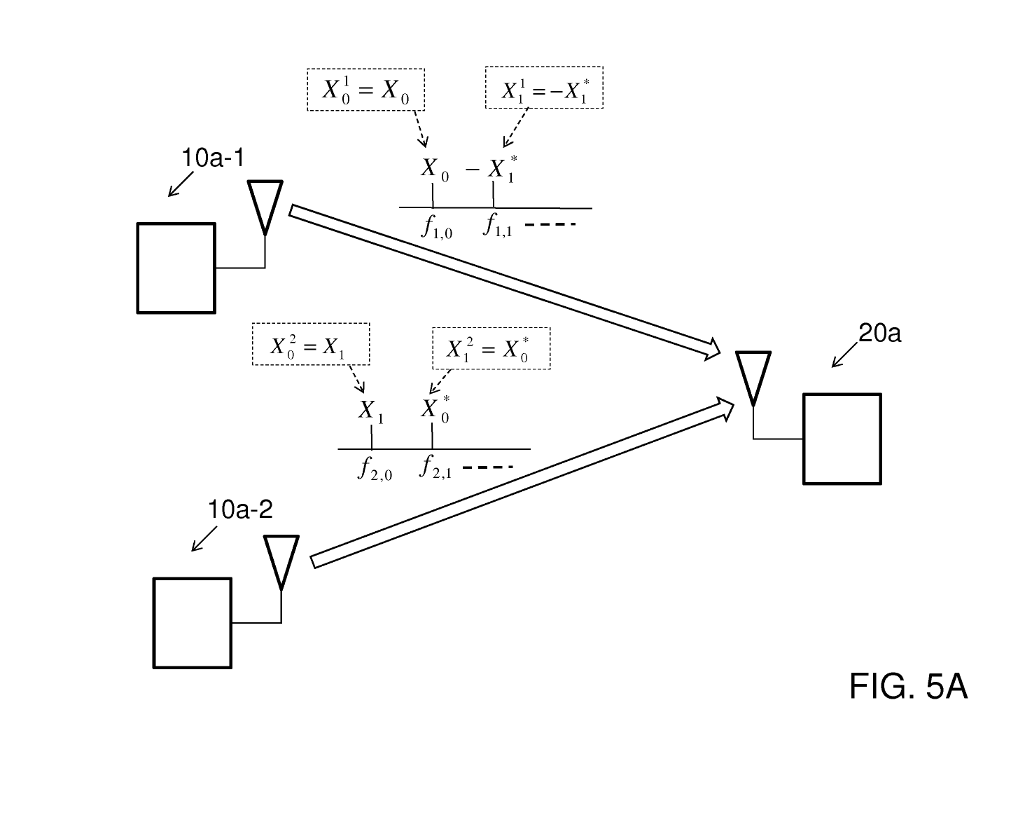

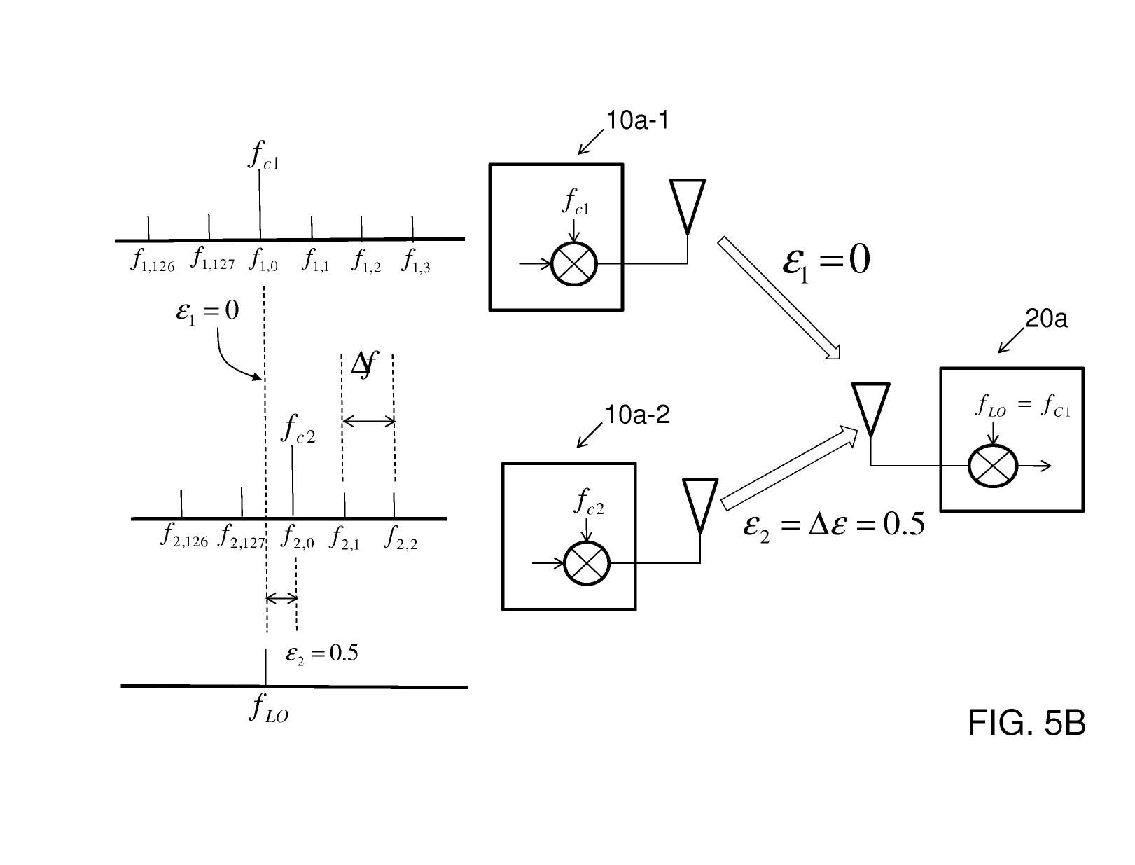

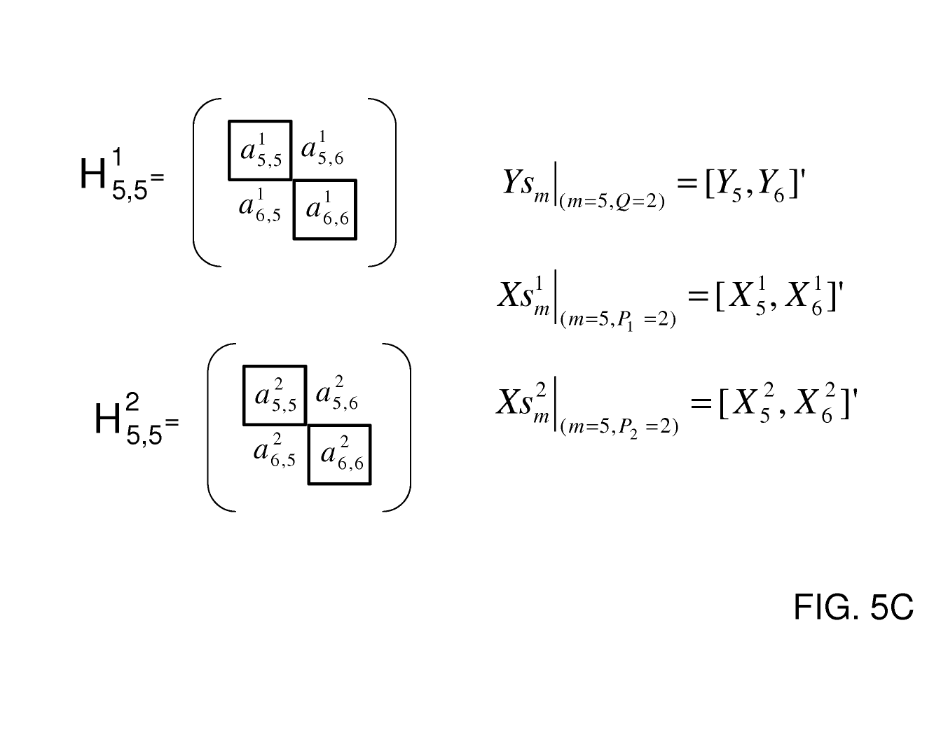

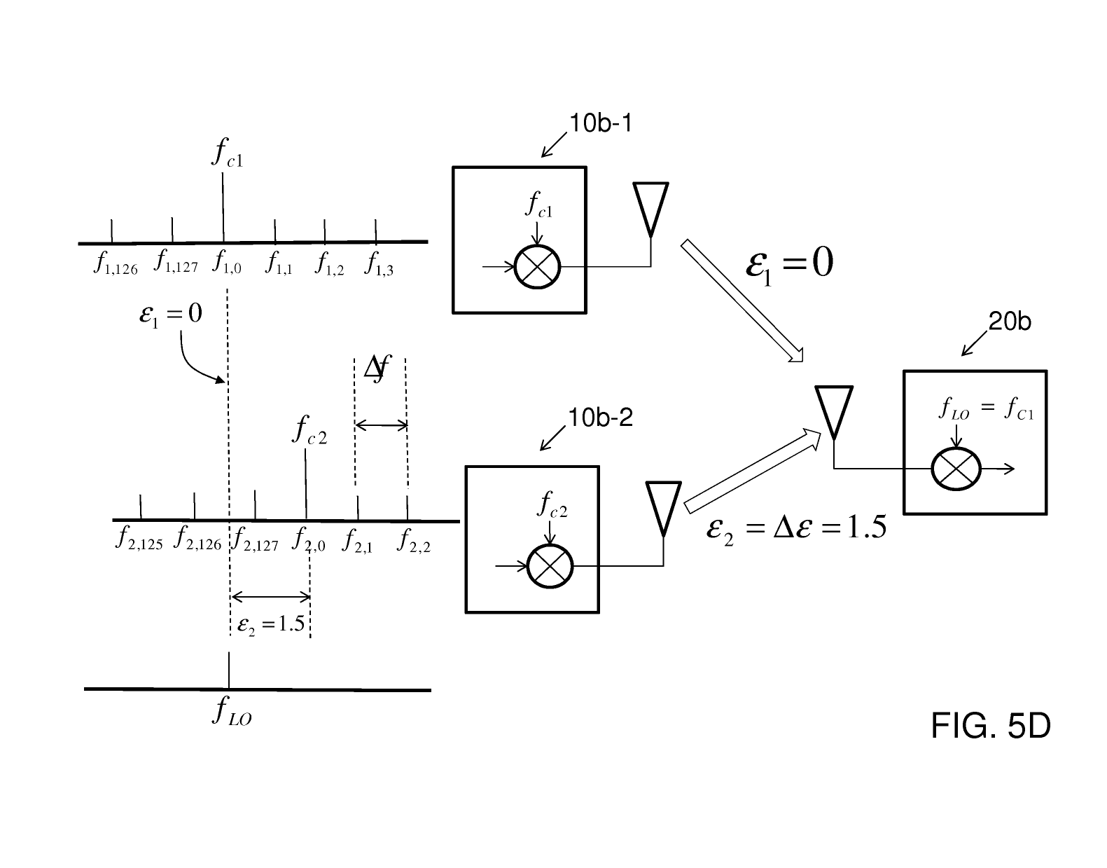

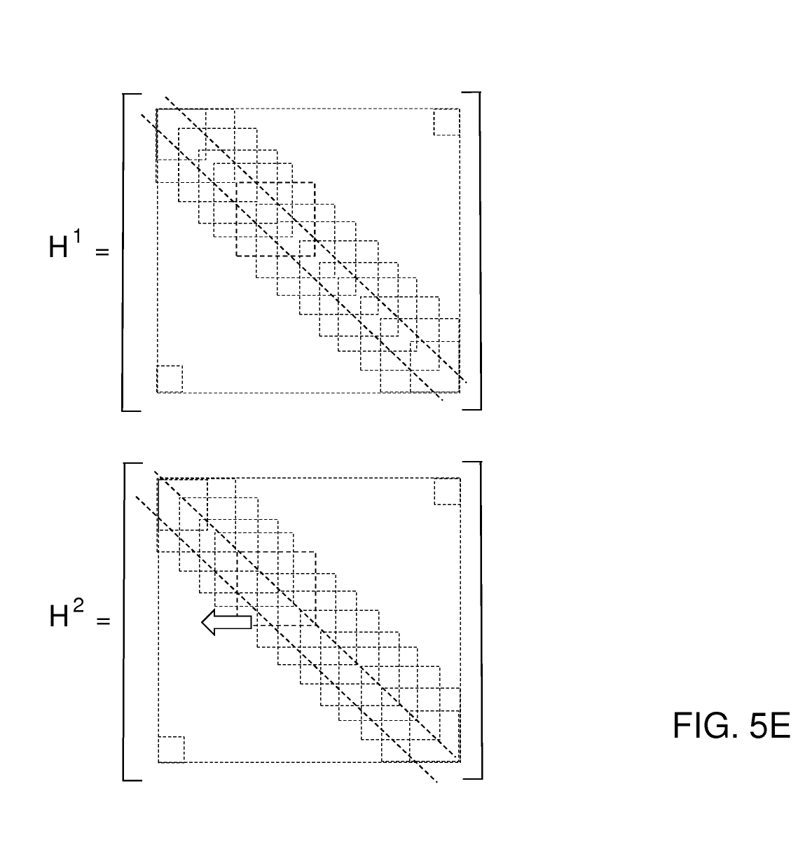

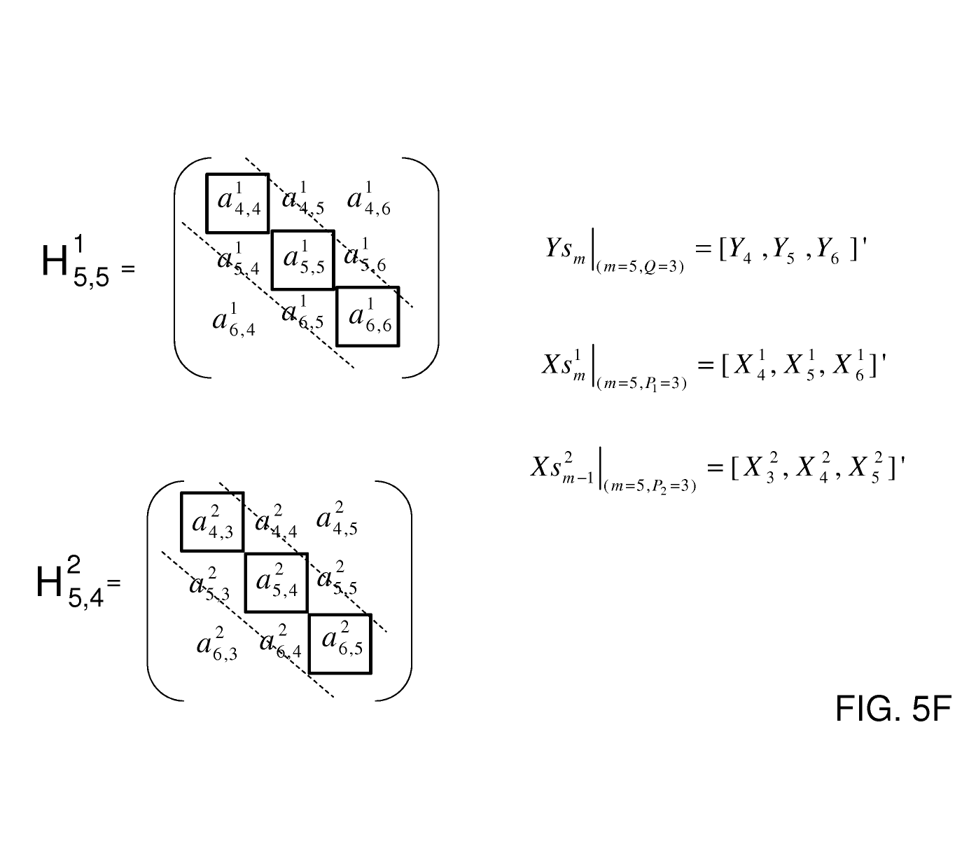

To operate with the receiver 20a which uses the MLSE-based detection performed by either the signal detector 46 illustrated by FIG. 4A, the computing unit 58 illustrated by FIG. 4F or the signal detector 46a illustrated by FIG. 4G, the transmitters 10a-1 and 10a-2 may be configured to operate with an Alamouti-type coding. Detail operation of such transmitters 10a-1 and 10a-2 will be discussed in the following paragraphs by reference to FIGS. 5A to 5F.

FIG. 5A illustrates an Alamouti-type coding for the cooperative OFDM communication system 2 illustrated in FIG. 3A in accordance with another example embodiment. Referring to FIG. 5A, data denoted as X₀ and X₁ may be two successive data from a data source (not shown) associated with the transmitters 10a-1 and 10a-2. Furthermore, subcarriers indexed “1,0” and “1,1” corresponding to the transmitter 10a-1 (which may be also denoted as f_{1,0} and f_{1,1}), may be two successive subcarriers in an OFDM symbol. Likewise, subcarriers indexed “2,0” and “2,1” corresponding to the transmitter 10a-2 (which may be also denoted as f_{2,0} and f_{2,1}), may be two successive subcarriers in an OFDM symbol. With the Alamouti-type coding, the transmitter 10a-1 may be configured to transmit data “−X₁*” over the subcarrier f_{1,1}, while the transmitter 10a-2 may be configured to transmit data “X₀*” over the subcarrier f_{2,1}, with the superscript “*” denoting complex conjugation.

FIG. 5B illustrates carrier frequency offsets (CFOs) in the cooperative OFDM communication system 2 illustrated in FIG. 3A in accordance with an example embodiment. Referring to FIG. 5B, each of the transmitters 10a-1 and 10a-2 may have a CFO with respect to the receiver 20a. The carrier frequency of the transmitter 10a-1 may be denoted as f_{c1}, while the carrier frequency of the transmitter 10a-2 may be denoted as f_{c2}. On the other hand, the frequency of a sinusoidal signal generated by a local oscillator (not shown) of the receiver 20a may be denoted as f_{LO}. The difference between f_{c1} and f_{LO} may be defined as the CFO between the transmitter 10a-1 and the receiver 20a. Likewise, the difference between f_{c2} and f_{LO} may be defined as the CFO between the transmitter 10a-2 and the receiver 20a. In this example embodiment, the CFOs for the transmitters 10a-1 and 10a-2 may be normalized with respect to the subcarrier spacing Δf. Such a normalized CFO for the transmitter 10a-1 may be denoted as ∈₁, while the normalized CFO for the transmitter 10a-2 may be denoted as ∈₂. Furthermore, a difference between ∈ᵢ and ∈₂ may be denoted as Δ∈.

In this example embodiment, the receiver 20a may be synchronized to the transmitter 10a-1. Therefore, the normalized CFO ∈₁ may be equal to zero, and the normalized CFO ∈₂ may thus be equal to Δ∈. Furthermore, the cooperative OFDM communication system 2 may have a MCFO span less than one subcarrier spacing, such as, Δ∈=0.5. Moreover, each of the channels (not shown) between the transmitters 10a-1, 10a-2 and the receiver 20a may have a Doppler spread with a nonzero peak Doppler frequency f_{d}=0.5 Hz.

Regarding such a fractional MCFO span in relation to the subcarrier spacing not exceeding 0.5 in value and such a small Doppler spread, the receiver 20a may be configured to perform the blockwise whitening process based on relatively small lengths Q, P₁ and P₂ for the sub-vectors Ysₘ, Xsₘ¹ and Xsₘ² and relatively small size for the sub-matrices H_{m,m}¹ and H_{m,m}². For example, each of the sub-vectors Ysₘ, Xsₘ¹ and Xsₘ² may have a length of 2, and each of the sub-matrices H_{m,m}¹ and H_{m,m}² may have a size of 2×2. In addition, the MLSE-based detection, which may be executed subsequent to the blockwise whitening process, may be performed based on trellis structure formed according to Xsₘ¹, Xsₘ², and the sub-matrices H_{m,m}¹ and H_{m,m}².

FIG. 5C illustrates sub-matrices H_{5,5}¹ and H_{5,5}² of the channels 30a-1 and 30a-2 in the cooperative OFDM communication system 2 illustrated in FIG. 3A in accordance with another example embodiment, as well as the corresponding sub-vectors Ys₅, Xs₅¹ and Xs₅². Referring to FIG. 5C and taking the subcarrier indexed “5” as an example, the trellis structure may be formed according to the center diagonals a_{5,5}¹ and a_{6,6}¹ of the sub-matrix H_{5,5}¹ together with the center diagonals a_{5,5}² and a_{6,6}² of the sub-matrix H_{5,5}².

FIG. 5D illustrates CFOs in a cooperative OFDM communication system 3 in accordance with still another example embodiment, and FIG. 5E illustrates the channel matrices H¹ and H² of the channels 30b-1 and 30b-2 in the cooperative OFDM communication system 3 illustrated in FIG. 5D in accordance with still another example embodiment. Referring to FIG. 5D, the cooperative OFDM communication system 3 may be similar to the cooperative OFDM communication system 2 illustrated in FIGS. 5A and 5B except that, the cooperative OFDM communication system 3 may have a MCFO span greater than one subcarrier spacing, such as, Δ∈=1.5. Due to such a relatively large MCFO span, the main signal and ICI power associated with the in-band portion of channel matrix H² may have a shift with respect to the diagonal, as shown in FIG. 5E. To cover such a MCFO span and hence the shift of the main signal and ICI power, the receiver 20b of the cooperative OFDM communication system 3 may be configured to perform blockwise whitening process and the subsequent MLSE-based detection based on the sub-vectors Ysₘ and Xsₘ¹, the sub-matrix H_{m,m}¹, and a shifted sub-vector Xsₘ₋₁² and a shifted sub-matrix H_{m,m-1}². In this example embodiment, each of the sub-vectors Ysₘ, Xsₘ¹ and Xsₘ₋₁² may have a length of 3, and each of the sub-matrices H_{m,m}¹ and H_{m,m-1}² may have a size of 3×3. In addition, the MLSE-based detection, which may be executed subsequent to the blockwise whitening process, may be performed based on trellis structure formed according to Xsₘ¹, Xsₘ₋₁², and the sub-matrices H_{m,m}¹, and H_{m,m-1}².

FIG. 5F illustrates the sub-matrices H_{5,5}¹ and H_{5,4}² of the channels 30b-1 and 30b-2, together with the corresponding sub-vectors Ys₅, Xs₅¹ and Xs₄², in the cooperative OFDM communication system 3 illustrated in FIG. 5D in accordance with another example embodiment. Referring to FIG. 5F and taking the subcarrier indexed “5” as an example, in the sub-matrix H_{5,4}², main ICI power may have a shift and thus reside on the first sub-diagonal element a_{5,4}². Accordingly, in this example embodiment, the trellis structure at the subcarrier indexed “5” for the MLSE-based detection may be formed according to the sub-vectors Xs₅¹ and Xs₄² and the sub-matrices H_{5,5}¹ and H_{5,4}².

It will be appreciated by those skilled in the art that changes could be made to the examples described above without departing from the broad inventive concept thereof. It is understood, therefore, that the various embodiments are not limited to the particular examples disclosed, but it is intended to cover modifications within the spirit and scope of the various embodiments and as defined by the appended claims.

Further, in describing representative examples of the various embodiments, the specification may have presented the method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the various embodiments should not be limited to the performance of their steps in the order written, and one skilled in the art can readily appreciate that the sequences may be varied and still remain within the spirit and scope of the various embodiments.

We claim:

1. A receiver for processing frequency division multiplexing (FDM) signals, the receiver comprising:
a processor configured to:
convert the FDM signals from at least two transmitters into frequency domain signals;
determine a first component of the frequency domain signals, the first component of the frequency domain signals comprising a channel noise and a composite residual inter-carrier interference (ICI) contributed by the at least two transmitters;
calculate a set of correlation values corresponding to the first component of the frequency domain signals; and
process the first component of the frequency domain signals based on the set of correlation values.

2. The receiver of claim 1, wherein the FDM signals comprise orthogonal frequency division multiplexing (OFDM) signals.

3. The receiver of claim 1, wherein the processor is configured to convert the FDM signals to the frequency domain signals by a discrete Fourier transform (DFT).

4. The receiver of claim 1, wherein the processor is configured to perform a whitening process on the first component of the frequency domain signals.

5. The receiver of claim 1, wherein the FDM signals are transmitted over a set of subcarriers through channels between the at least two transmitters and the receiver.

6. The receiver of claim 1, wherein the frequency domain signals further comprise a second component, the second component of the frequency domain signals comprising a composite in-band signal contributed by the at least two transmitters.

7. The receiver of claim 6, wherein the first component of the frequency domain signals is determined by subtracting the second component of the frequency domain signals from the frequency domain signals

8. The receiver of claim 5, wherein the composite residual ICI is induced by time-variation of the channels between the at least two transmitters and the receiver.

9. The receiver of claim 1, wherein each of the at least two transmitters has a carrier frequency offset (CFO) with respect to the receiver.

10. The receiver of claim 1, wherein the processor is configured to estimate channel state information of channels between the at least two transmitters and the receiver.

11. The receiver of claim 10, wherein the processor is configured to generate at least two channel matrices based on the channel state information, each of the at least two channel matrices has a predefined bandwidth.

12. The receiver of claim 11, wherein the processor is configured to perform the whitening process on the first component of the frequency domain signals based on the predefined bandwidth of each of the at least two channel matrices.

13. The receiver of claim 12, wherein the processor is configured to detect the frequency domain signals based on one of maximum-likelihood sequence estimation (MLSE) and minimum mean square error (MMSE) detection methods.

14. The receiver of claim 11, wherein the processor is configured to decompose each of the at least two channel matrices into a plurality of sub-matrices, each of the sub-matrices has a predefined size.

15. The receiver of claim 14, wherein the processor is configured to truncate the frequency domain signals into a plurality of subsets of signals, each of the subsets of signals has a predefined length.

16. The receiver of claim 15, wherein the processor is configured to perform the whitening process on the first component of the frequency domain signals based on the predefined size of each of the sub-matrices and the predefined length of each of the subsets of signals.

17. The receiver of claim 16, wherein the processor is configured to detect each of the subsets of signals based on one of maximum-likelihood sequence estimation (MLSE) and minimum mean square error (MMSE) detection methods.

18. A method for processing frequency division multiplexing (FDM) signals, the method comprising:
receiving the FDM signals from at least two transmitters;
converting the FDM signals to frequency domain signals;
determining a first component of the frequency domain signals, the first component of the frequency domain signals comprising a channel noise and a composite residual inter-carrier interference (ICI) contributed by the at least two transmitters;
calculating a set of correlation values corresponding to the first component of the frequency domain signals; and
processing the first component of the frequency domain signals based on the set of correlation values.

19. The method of claim 18, wherein the FDM signals comprise orthogonal frequency division multiplexing (OFDM) signals.

20. The method of claim 18, wherein the FDM signals are converted to the frequency domain signals by a discrete Fourier transform (DFT).

21. The method of claim 18, wherein the first component of the frequency domain signals is processed by a whitening process.

22. The method of claim 18, wherein the FDM signals are transmitted over a set of subcarriers through channels between the at least two transmitters and a receiver.

23. The method of claim 18, wherein the frequency domain signals further comprise a second component, the second component of the frequency domain signals comprising a composite in-band signal contributed by the at least two transmitters.

24. The method of claim 23, wherein the first component of the frequency domain signals is determined by subtracting the second component of the frequency domain signals from the frequency domain signals.

25. The method of claim 18, wherein each of the at least two transmitters has a carrier frequency offset (CFO) with respect to the receiver.

26. The method of claim 18 further comprises:
estimating channel state information of channels between the at least two transmitters and a receiver; and
generating at least two channel matrices based on the channel state information,
wherein each of the at least two channel matrices has a predefined bandwidth.

27. The method of claim 26, wherein a whitening process is performed on the first component of the frequency domain signals based on the predefined bandwidth of each of the at least two channel matrices.

28. The method of claim 27 further comprises:
detecting the frequency domain signals based on a detection method.

29. The method of claim 28, wherein the detection method comprises one of maximum-likelihood sequence estimation (MLSE) and minimum mean square error (MMSE) detection.

30. The method of claim 26 further comprises:
decomposing each of the at least two channel matrices into a plurality of sub-matrices,
wherein each of the sub-matrices has a predefined size.

31. The method of claim 30 further comprises:
truncating the frequency domain signals into a plurality of subsets of signals,
wherein each of the subsets of signals has a predefined length.

32. The method of claim 31, wherein the whitening process is performed on the first component of the frequency domain signals based on the predefined size of each of the sub-matrices and the predefined length of each of the subsets of signals.

33. The method of claim 32 further comprises:
detecting each of the subsets of signals based on a detection method.

34. The method of claim 33, wherein the detection method comprises one of maximum-likelihood sequence estimation (MLSE) and minimum mean square error (MMSE) detection.
